(19) United States
(12) Patent Application Publication
(10) Pub. No.: US 2011/0169725 A1
(43) Pub. Date: Jul. 14, 2011

(54) FUNCTION MEASURING DEVICE

(76) Inventors: Hiromu Ueshima, Shiga (JP); Akimasa Konishi, Shiga (JP)

(21) Appl. No.: 12/293,775

(22) PCT Filed: Mar. 13, 2007
(86) PCT No.: PCT/JP2007/000213

§ 371 Date: Aug. 8, 2010

(30) Foreign Application Priority Data
Mar. 23, 2006 (JP) 2006-079829
Apr. 11, 2006 (JP) 2006-108946
Jun. 28, 2006 (JP) 2006-178828
Jul. 27, 2006 (JP) 2006-204527

(51) Int. Cl. G09G 5/00

(52) U.S. Cl. 345/156

(57) ABSTRACT

[PROBLEM TO BE SOLVED] To provide a newly function measurement apparatus capable of measuring a function of a person while a test subject moves a whole body thereof.

[SOLUTION] A mat unit 7 includes foot switches SW1 to SW4, and detects step motion of a test subject. The test subject performs the step motion on the foot switches SW2 and SW3 while sitting. ON/OFF information of the foot switches SW1 to SW4 is transmitted to an adapter 1 by infrared communication. A cartridge 3 is inserted into the adapter 1. The ON/OFF information of the foot switches SW1 to SW4 is sent to the cartridge 3 via the adapter 1. A processor 20 incorporated in the cartridge 3 measures a time from when any one of the foot switches SW2 and SW3 detects the step motion to when the predetermined number of times of the step motion is detected. The measuring result is displayed on a television monitor 5.

### TECHNICAL FIELD

The present invention relates to a function measurement apparatus and the related arts for measuring a function (a faculty), such as a motor function (a motor performance) of a person.

### BACKGROUND ART

The Patent Document 1 explains a general method for measuring a “vertical jump”.In accordance with this Document, first of all, a blackboad is put on a wall, and a line is drawn parallel to the wall at a distance of 20 centimeters from the wall on a floor surface. A test subject adjusts a direction of a body in such a manner that either the right side or the left side of the body faces the wall, and stands with both feet together in such a manner that the wall-side foot is externally brought into contact with the line drawn on the floor surface. Chalk dust is put on the tip of a finger of a wall-side hand, for a start, the arm is extended upward on the straight (in this case, the heels must not be lifted), and then the blackboard is touched with the tip of the finger to be marked by the chalk dust. Next, the arm lifted once is lowered, then the arm is extended upward again while jumping as high as possible on the spot without a run-up and so on, and the mark is placed on the blackboard at the uppermost point with the chalk dust. The jump is performed twice, then the vertical distance between the higher mark and the mark before jumping is measured, and the result is used as the record of the test subject.

By the way, the “vertical jump” can be used as a criterion of evaluating instantaneous force of the test subject.

Patent Documentl: Japanese Unexamined Patent Application Publication No. 2000-300710

### DISCLOSURE OF THE INVENTION

### Problem to be Solved by the Invention

However, In the case of desiring to know the instantaneous force, the measurement of the vertical distance in the “vertical jump” is not necessarily required. Also, besides the instantaneous force, there are various things as a motor function (a motor performance) of a person, such as reflexes, elaborateness, agility, walking ability, and rhythm. Further, besides these things, there are various things as the function (the faculty) of the person, such as a faculty to memorize, judgment, and ability to concentrate. If the person can improve these functions (faculties) by knowing them about oneself, contribution to recovery, maintenance, enhancement, and so on of physical and mental health can be expected.

It is therefore an object of the present invention to provide a novel function measurement apparatus and the related techniques thereof capable of measuring a function of a person while a test subject moves a whole body thereof.

### Solution of the Problem

In accordance with a first aspect of the present invention, a function measurement apparatus to be used in connection with a display device, comprising: a detecting unit operable to detect step action as input from a test subject; a measuring unit operable to measure a time from when said detecting unit detects the step action to when a predetermined number of times of the step action is detected; and a display control unit operable to display a measuring result of said measuring unit on the display device. In this case, the time as measured is a criterion for evaluating agility which is one of motor functions of the test subject. In this way, the agility of the test subject is measured by detecting the step action of the test subject.

In this case, an acceptation of the detecting unit includes a unit which is attached to the test subject and detects the step action of the test subject, and a unit which photographs the test subject to detect the step action of the test subject.

In accordance with another aspect of the present invention, a function measurement apparatus to be used in connection with a display device, comprising: a plurality of step parts each of which includes a detecting unit operable to detect step action as input from a test subject; a measuring unit operable to measure a time from when any one of said detecting units detects the step action to when a predetermined number of times of the step action is detected; and a display control unit operable to display a measuring result of said measuring unit on the display device.

In accordance with this configuration, the time taken by the test subject for stepping by the predetermined number of times of the steps is measured. The time as measured is a criterion for evaluating the agility which is one of the motor functions of the test subject. That is, as the time as measured is shorter, the agility is higher, while as the time as measured is longer, the agility is lower. Also, since the test subject gets exercise through such measurement, this function measurement apparatus serves also as an exercise assistance apparatus.

In the above function measurement apparatus, wherein said detecting unit detects the step action which the test subject performs in a state of sitting.

In accordance with a second aspect of the present invention, a function measurement apparatus to be used in connection with a display device, comprising: a detecting unit operable to detect step action as input from a test subject; a guide unit operable to guide timing of stepping at a predetermined time interval by an image and/or audio; a measuring unit operable to measure a step interval, which is a time from when said detecting unit detects the step action to when the next step action is detected; a difference calculating unit operable to a difference between the predetermined time interval and the step interval measured after finishing the guide; and a display control unit operable to display an image for representing the difference visually on the display device, wherein said measuring unit measures the step interval for the each step action until said detecting unit detects a predetermined number of times of the step action, and wherein said difference calculating unit calculates the difference for the each step action. In this case, magnitude of the difference is indicative whether or not the test subject can perform the stepping with the indicated rhythm (i.e., at the predetermined time interval). As the result, the magnitude of the difference is a criterion for evaluating rhythmic sense of the test subject. In this way, the rhythmic sense of the test subject is measured by detecting the stepping of the test subject.

In this case, an acceptation of the detecting unit includes a unit which is attached to the test subject and detects the step action of the test subject, and a unit which photographs the test subject to detect the step action of the test subject.

In accordance with another aspect of the present invention, a function measurement apparatus to be used in connection with a display device, comprising: a plurality of step parts each of which includes a detecting unit operable to detect step action as input from a test subject; a guide unit operable to guide timing of stepping at a predetermined time interval by an image and/or audio; a measuring unit operable to measure a step interval, which is a time from when any one of said detecting unit detects the step action to when the other detecting unit detects the next step action; a difference calculating unit operable to a difference between the predetermined time interval and the step interval measured after finishing the guide; and a display control unit operable to display an image for representing the difference visually on the display device. In this case, said measuring unit measures the step interval for the each step action until said detecting units detect a predetermined number of times of the step action, and wherein said difference calculating unit calculates the difference for the each step action.

In accordance with this configuration, the step interval of the test subject is measured, and further the difference between the step interval and the predetermined time interval is computed. Magnitude of the difference is indicative whether or not the test subject can perform the stepping with the indicated rhythm (i.e., at the predetermined time interval). As the result, the magnitude of the difference is a criterion for evaluating rhythmic sense of the test subject. Also, since the test subject gets exercise through such measurement, this function measurement apparatus serves also as an exercise assistance apparatus.

In accordance with a third aspect of the present invention, a function measurement apparatus to be used in connection with a display device, comprising: a detecting unit operable to detect jump action as input from a test subject; a hangtime measuring unit operable to measure a hangtime, which is a time from when said detecting unit detects flight of the test subject to when ground contact of the test subject is detected; and a display control unit operable to display the hangtime as a measuring result of said hangtime measuring unit on the display device. Also, this function measurement apparatus further comprising: a ground contact time measuring unit operable to measure a ground contact time, which is a time from when said detecting unit detects the ground contact of the test subject to when the flight is detected, wherein said hangtime measuring unit measures a predetermined number of times of the successive hangtimes, and wherein said ground contact time measuring unit measures the predetermined number of the times of the successive ground contact times.

In this case, the hangtime as measured is a criterion for evaluating instantaneous force (a faculty of exerting force rapidly) of the test subject. In this way, the instantaneous force of the test subject is measured by detecting the stepping of the test subject. Also, it is possible to calculate the flight rate based on the average of the predetermined number of times of the hangtimes and the average of the predetermined number of times of the ground contact times. The flight rate is a criterion for evaluating response muscular force of the test subject, i.e. , ability which efficiently draws spring of muscle and sinew in the short ground contact time. In this way, the response muscular force of the test subject is measured by detecting the stepping of the test subject.

In this case, an acceptation of the detecting unit includes a unit which is attached to the test subject and detects the step action of the test subject, and a unit which photographs the test subject to detect the step action of the test subject.

On the other hand, in accordance with another aspect of the present invention, a function measurement apparatus to be used in connection with a display device, comprising: a plurality of stamp parts each of which includes a detecting unit operable to detect stamp action as input from a test subject; a hangtime measuring unit operable to measure a hangtime, which is a time from a state in which all said detecting units do not detect the stamp action to when any one of said detecting units detects the stamp action; and a display control unit operable to display the hangtime as a measuring result of said hangtime measuring unit on the display device .

In accordance with this configuration, the hangtime of the test subject is measured. The hangtime as measured in such a manner is a criterion for evaluating instantaneous force (a faculty of exerting force rapidly) of the test subject. Also, since the test subject gets exercise through such measurement, this function measurement apparatus serves also as an exercise assistance apparatus.

In this case, this function measurement apparatus further comprises: a ground contact time measuring unit operable to measure a ground contact time, which is a time from a state in which any one of said detecting units detects the stamp action to when all said detecting units do not detect the stamp action, wherein said hangtime measuring unit measures a predetermined number of times of the successive hangtimes, and wherein said ground contact time measuring unit measures the predetermined number of the times of the successive ground contact times.

In accordance with this configuration, the predetermined number of times of the hangtimes and the predetermined number of times of the ground contact times are measured. Accordingly, it is possible to calculate the flight rate based on the average “Aa” of the predetermined number of times of the hangtimes and the average “Ag” of the predetermined number of times of the ground contact times. For example, the flight rate is given by

Aa/(Aa+Ag).

The flight rate is a criterion for evaluating response muscular force of the test subject, i.e., ability which efficiently draws spring of muscle and sinew in the short ground contact time.

In accordance with a fourth aspect of the present invention, a function measurement apparatus to be used in connection with a display device, comprising: a detecting unit operable to detect ground contact and non-ground contact of a leg of a test subject; an instructing unit operable to instruct the test subject to measure a predetermined time by the display device or audio; a starting unit operable to show a point of time when time-measurement is started to the test subject by the display device or audio after the instructing; and a time-measurement unit operable to start the time-measurement from the point of the time when the time-measurement is started, and finish the time-measurement when said detecting unit detects a predetermined transition of a transition from the ground contact of the leg to the non-ground contact and a transition from the non-ground contact of the leg to the ground contact. In this case, it is possible to evaluate accuracy of the mechanism for measuring time by the test subject, i.e., the biological clock of the test subject by obtaining the difference between the time-measurement result and the predetermined time instructed by the instructing unit.

In this case, an acceptation of the detecting unit includes a unit which is attached to the test subject and detects the step action of the test subject, and a unit which photographs the test subject to detect the step action of the test subject.

In accordance with another aspect of the present invention, a function measurement apparatus to be used in connection with a display device, comprising: a plurality of step parts each of which includes a detecting unit operable to detect ground contact and non-ground contact of a leg of a test subject; an instructing unit operable to instruct the test subject to measure a predetermined time by the display device or audio; a starting unit operable to show a point of time when time-measurement is started to the test subject by the display device or audio after the instructing; and a time-measurement unit operable to start the time-measurement from the point of the time when the time-measurement is started, and finish the time-measurement when said detecting unit detects a predetermined transition of a transition from the ground contact of the leg to the non-ground contact and a transition from the non-ground contact of the leg to the ground contact.

In accordance with this configuration, it is possible to evaluate accuracy of the mechanism for measuring time by the test subject, i.e., the biological clock of the test subject by obtaining the difference between the time-measurement result and the predetermined time instructed by the instructing unit.

In accordance with a fifth aspect of the present invention, a function measurement apparatus to be used in connection with a display device, comprising: a detecting unit operable to detect stamp action as input from a test subject; a guide unit operable to indicates a stamp position where the test subject has to stamp; a time-measurement unit operable to start time-measurement from a point of time when the guide unit indicates the stamp position where the test subject has to stamp, and finish the time-measurement when the test subject stamps the stamp position; and a result display unit operable to display a time-measurement result of said time-measurement unit on the display device. In this case, said guide unit repeatedly indicates the stamp position where the test subject has to stamp. By the time-measurement result, it is possible to know the extent to which the test subject can quickly stamp the stamp position indicated by the guide unit.

In this case, an acceptation of the detecting unit includes a unit which is attached to the test subject and detects the stamp action of the test subject, and a unit which photographs the test subject to detect the stamp action of the test subject.

In accordance with another aspect of the present invention, a function measurement apparatus to be used in connection with a display device, comprising: a plurality of stamp parts each of which includes a detecting unit operable to detect stamp action as input from a test subject; a guide unit operable to indicates the stamp part where the test subject has to stamp; a time-measurement unit operable to start time-measurement from a point of time when the guide unit indicates the stamp part where the test subject has to stamp, and finish the time-measurement when the test subject stamps the stamp part; and a result display unit operable to display a time-measurement result of said time-measurement unit on the display device.

In accordance with this configuration, by the time-measurement result, it is possible to know the extent to which the test subject can quickly stamp the stamp part indicated by the guide unit.

In this function measurement apparatus, wherein said guide unit repeatedly indicates the stamp part where the test subject has to stamp.

In accordance with a sixth aspect of the present invention, a function measurement apparatus to be used in connection with a display device, comprising: a detecting unit operable to detect stamp action as input from a test subject; a guide unit operable to repeatedly indicates a stamp position where the test subject has to stamp, using the display device; a time-measurement unit operable to start time-measurement from a point of time when the guide unit first indicates the stamp position where the test subject has to stamp, and finish the time-measurement when a predetermined time elapses; and a counting unit operable to count a number of times of stamps when the test subject stamps the stamp position indicated by the guide unit; and a result display unit operable to display a count result of said counting unit on the display device. In this case, by the count result, it is possible to know how many times the test subject can stamp the stamp position indicated by the guide unit within the predetermined time period.

In this case, an acceptation of the detecting unit includes a unit which is attached to the test subject and detects the stamp action of the test subject, and a unit which photographs the test subject to detect the stamp action of the test subject.

In accordance with another aspect of the present invention, a function measurement apparatus to be used in connection with a display device, comprising: a plurality of stamp parts each of which includes a detecting unit operable to detect stamp action as input from a test subject; a guide unit operable to repeatedly indicates the stamp part where the test subject has to stamp, using the display device; a time-measurement unit operable to start time-measurement from a point of time when the guide unit first indicates the stamp part where the test subject has to stamp, and finish the time-measurement when a predetermined time elapses; and a counting unit operable to count a number of times of stamps when the test subject stamps the stamp part indicated by the guide unit; and a result display unit operable to display a count result of said counting unit on the display device.

In accordance with this configuration, by the count result, it is possible to know how many times the test subject can stamp the stamp part indicated by the guide unit within the predetermined time period.

In accordance with a seventh aspect of the present invention, a function measurement apparatus to be used in connection with a display device, comprising: a detecting unit operable to detect stamp action as input from a test subject; and a guide unit operable to indicates order of a plurality of stamp positions to be stamped by the test subject, using the display device, wherein the order is fixed, wherein said guide unit repeatedly indicates the order, and shortens a time for indicating the order in accordance with increment of a number of times of the indication, and said function measurement apparatus further comprising: a determining unit operable to instruct said guide unit to finish indicating the order when said determining unit determines that the test subject does not perform the stamp action in accordance with the indication of said guide unit based on a detection result of said detecting unit. In this case, since the time when the order is indicated shortens gradually, it is difficult for the test subject to stamp the stamp position as indicated. Accordingly, information, which represents to which level the test subject can perform the stamp motion according to the indication, is a criterion of the motor function of the test subject.

In this case, an acceptation of the detecting unit includes a unit which is attached to the test subject and detects the stamp action of the test subject, and a unit which photographs the test subject to detect the stamp action of the test subject.

In accordance with another aspect of the present invention, a function measurement apparatus to be used in connection with a display device, comprising: a plurality of stamp parts each of which includes a detecting unit operable to detect stamp action as input from a test subject; and a guide unit operable to indicates order of the plurality of stamp parts to be stamped by the test subject, using the display device. In this case, the order is fixed, wherein said guide unit repeatedly indicates the order, and shortens a time for indicating the order in accordance with increment of a number of times of the indication, and said function measurement apparatus further comprising: a determining unit operable to instruct said guide unit to finish indicating the order when said determining unit determines that the test subject does not perform the stamp action in accordance with the indication of said guide unit based on detection results of said detecting units.

In accordance with this configuration, since the time when the order is indicated shortens gradually, it is difficult for the test subject to stamp the stamp part as indicated. Accordingly, information, which represents to which level the test subject can perform the stamp motion according to the indication, is a criterion of the motor function of the test subject.

In accordance with a eighth aspect of the present invention, a function measurement apparatus to be used in connection with a display device, comprising: a detecting unit operable to detect stamp action as input from a test subject; and a correspondence image display unit operable to display a plurality of correspondence images corresponding to a plurality of stamp positions on the display device; and an information display unit operable to display at least two information display sections corresponding to at least two of the plurality of the correspondence images on the display device. In this case, it is possible to have the test subject select one or more information display sections with the stamp motion. Accordingly, it is possible to show the task to the test subject by the contents to be displayed in the information display sections to obtain the answer. In this function measurement apparatus, wherein said information display unit displays information in one of the plurality of the information display sections, and wherein the information has a different kind of content from a content of information to be displayed in the other information display section. Also, in this function measurement apparatus, wherein said information display unit may display the two information display sections corresponding to the two correspondence images of the plurality of the correspondence images to display information indicating different numerals from each other therein. Further, in this function measurement apparatus, wherein said information display unit may display the two information display sections corresponding to the two correspondence images of the plurality of the correspondence images to display either information indicating different numerals from each other or information indicating same numerals as each other therein.

In this case, an acceptation of the detecting unit includes a unit which is attached to the test subject and detects the stamp action of the test subject, and a unit which photographs the test subject to detect the stamp action of the test subject.

In accordance with another aspect of the present invention, a function measurement apparatus to be used in connection with a display device, comprising: a plurality of step parts each of which includes a detecting unit operable to detect ground contact and non-ground contact of a leg of a test subject; and a correspondence image display unit operable to display a plurality of correspondence images corresponding to the plurality of stamp parts on the display device; and an information display unit operable to display at least two information display sections corresponding to at least two of the plurality of the correspondence images on the display device.

In accordance with this configuration, it is possible to have the test subject select one or more information display sections with the stamp parts. Accordingly, it is possible to show the task to the test subject by the contents to be displayed in the information display sections to obtain the answer.

In this function measurement apparatus, said information display unit displays information in one of the plurality of the information display sections, and wherein the information has a different kind of content from a content of information to be displayed in the other information display section.

In accordance with this configuration, it is possible to have the test subject select the information display section, in which the different kind of the content is displayed, with the stamp part. In this case, the speed and accuracy of the selection are a criterion for evaluating the judgment of the test subject.

Also, in this function measurement apparatus, said information display unit displays the two information display sections corresponding to the two correspondence images of the plurality of the correspondence images to display information indicating different numerals from each other therein.

In accordance with this configuration, it is possible to have the test subject select the information display section having the smaller value or the information display section having the larger value with the stamp part. In this case, the speed and accuracy of the selection are a criterion for evaluating the judgment of the test subject.

Further, in this function measurement apparatus, said information display unit displays the two information display sections corresponding to the two correspondence images of the plurality of the correspondence images to display either information indicating different numerals from each other or information indicating same numerals as each other therein.

In accordance with this configuration, it is possible to have the test subject answer what the values of the two information display sections are the same or what the values of the two information display sections are different from each other with the stamp part. In this case, the speed and accuracy of the determination are a criterion for evaluating the judgment of the test subject.

In accordance with a ninth aspect of the present invention, a function measurement apparatus to be used in connection with a display device, comprising: a detecting unit operable to detect stamp action as input from a test subject; and a guide unit operable to indicates order of a plurality of stamp positions to be stamped by the test subject, using the display device, wherein the order is optionally set, wherein said guide unit repeatedly indicates the order, and increases elements constituting the order in accordance with increment of a number of times of the indication, and said function measurement apparatus further comprising: a determining unit operable to instruct said guide unit not to subsequently indicate the order when said determining unit determines that the test subject does not perform the stamp action in accordance with the indication of said guide unit after the indication based on a detection result of said detecting unit which is caused by the stamp action of the test subject after said guide unit finishes the indication once. In this case, since the elements constituting the order increase gradually, it is difficult for the test subject to memorize the order of the stamp. Accordingly, information, which represents to which level the test subject can perform the stamp motion according to the indication, is a criterion for evaluating the faculty to memorize of the test subject.

In this case, an acceptation of the detecting unit includes a unit which is attached to the test subject and detects the stamp action of the test subject, and a unit which photographs the test subject to detect the stamp action of the test subject.

In accordance with another aspect of the present invention, a function measurement apparatus to be used in connection with a display device, comprising: a plurality of stamp parts each of which includes a detecting unit operable to detect stamp action as input from a test subject; and a guide unit operable to indicates order of the plurality of stamp parts to be stamped by the test subject, using the display device. In this case, wherein the order is optionally set, wherein said guide unit repeatedly indicates the order, and increases elements constituting the order in accordance with increment of a number of times of the indication, and said function measurement apparatus further comprising: a determining unit operable to instruct said guide unit not to subsequently indicate the order when said determining unit determines that the test subject does not perform the stamp action in accordance with the indication of said guide unit after the indication based on detection results of said detecting units which are caused by the stamp action of the test subject after said guide unit finishes the indication once.

In accordance with this configuration, since the elements constituting the order increase gradually, it is difficult for the test subject to memorize the order for stamping the stamp parts. Accordingly, information, which represents to which level the test subject can perform the stamp motion according to the indication, is a criterion for evaluating the faculty to memorize of the test subject.

In accordance with a tenth aspect of the present invention, a function measurement apparatus to be used in connection with a display device, comprising: a detecting unit operable to detect full body motion of a test subject; a display control unit operable to display an object, which moves in a cyclic manner, on the display device; a determining unit operable to determine success and failure based on a detection result of said detecting unit and a position of the object for each cycle; and a counting unit operable to increase a counted value when the determining unit determines the success.

In accordance with this configuration, it is possible to know the extent of the continuity of the action of the test subject while synchronizing with the object which moves in a cyclic manner.

In this function measurement apparatus, wherein when a first predetermined motion of the test subject is detected during a first period of the one cycle of the object, said determining unit determines the success if a second predetermined motion of the test subject is detected during a second period following the first period, and determines the failure if the second motion is not detected during the second period. In accordance with this configuration, it is possible to determine the success and the failure easily.

In the above function measurement apparatus, wherein the object is a curved line in appearance, such as a rope of a jump rope, and wherein the movement in the cyclic manner is rotational movement, such as rotational movement of a rope of a jump rope. In accordance with this configuration, the test subject can simulate the jump rope.

In this case, an acc ptation of the detecting unit includes a unit which is attached to the test subject and detects the step action of the test subject, and a unit which photographs the test subject to detect the step action of the test subject.

### BEST MODE FOR CARRYING OUT THE INVENTION

In what follows, an embodiment of the present invention will be explained in conjunction with the accompanying drawings. Meanwhile, like references indicate the same or functionally similar elements throughout the respective drawings, and therefore redundant explanation is not repeated.

FIG. 1 is a block diagram showing the entire configuration of a mat system as a function measurement system in accordance with an embodiment of the present invention. As shown in FIG. 1, the mat system includes an adapter 1, a cartridge 3, a mat unit 7, and a television monitor 5. The cartridge 3 is inserted into the adaptor 1. Also, the adapter 1 includes a power supply circuit, which supplies the cartridge with a power supply voltage. Further, the adaptor 1 is connected with the television monitor 5 by an AV cable 9. Accordingly, a video signal and an audio signal generated by the cartridge 3 are given to the television monitor 5 through the adapter 1 and the AV cable 9. As the result, the television monitor 5 displays various screens as described below, and outputs music and sound effect from a speaker (not shown in the figure) thereof.

The mat unit 7 is provided with a mat 2 and a circuit case 4. The circuit case 4 is fixed to one end of the mat 2. The circuit case 4 is provided with a power switch 8 at the upper surface thereof and an infrared ray filter 6 which transmits only infrared rays at one end thereof. An infrared light (IR) emitting unit 30 (as described below) including an infrared light emitting diode (not shown in the figure) is located behind the infrared ray filter 6. On the other hand, four step areas ST1, ST2, ST3 and ST4 are formed in the surface of the mat 2. The mat 2 is also provided with foot switches SW1, SW2, SW3 and SW4 inside thereof corresponding respectively to the step areas ST1, ST2, ST3 and ST4. When the step area ST1, ST2, ST3 or ST4 is stepped on, the corresponding one of the foot switches SW1, SW2, SW3 and SW4 is turned on. For example, the foot switches SW1 to SW4 are membrane switches.

FIG. 2 is a view for showing the electric configuration of the mat unit 7, the adapter 1, and the cartridge 3 of FIG. 1. Referring to FIG. 2, the mat unit 7 includes the infrared light (IR) emitting unit 30, an MCU (microcontroller unit) 32, and the foot switches SW1 to SW4. The IR emitting unit 30 and the MCU 32 are housed in the circuit case 4. The foot switches SW1 to SW4 are located inside of the mat 2. The MCU 32 receives on/off information from the foot switches SW1 to SW4, and drives the IR emitting unit 30 to transmit the on/off information of the foot switches SW1 to SW4 to an IR receiver 24 of the adapter 1 by infrared communication.

On the other hand, the cartridge 3 to be inserted into the adapter 1 includes a processor 20 and an external memory 22 (e.g., ROM). Also, the adapter 1 includes the infrared light (IR) receiver 24. The infrared ray signal transmitted by the IR emitting unit 30 of the mat unit 7, i.e., the on/off information of the foot switches SW1 to SW4 is received by the IR receiver 24 of the adapter 1, and then is sent to the processor 20 of the cartridge 3.

The processor 20 of the cartridge 3 is connected with the external memory 22. The external memory 22 includes a program area, an image data area, and a sound data area. Control programs (including application programs) are stored in the program area. The image data area stores all image data constituting each of various screens to be displayed on the television monitor 5, and the other necessary image data. The sound data area stores sound data of music and sound effect. The processor 20 executes the control program stored in the program area, reads the image data stored in the image data area and the sound data stored in the sound data area, and applies necessary processing thereto to generate a video signal and an audio signal. The video signal and the audio signal are supplied to the television monitor 5 through the adapter 1 and the AV cable 9. As the result, the various screens can be displayed on the television monitor 5, and whereby a test subject acts in accordance with instruction therefrom. Then, the processor 20 executes various measurement processes corresponding to the various screens as described below based on the on/off information of the foot switches SW1 to SW4 from the IR receiver 24.

Although not shown in the figure, the processor 20 includes various functional blocks, such as a CPU (central processing unit), a graphics processor, a sound processor and a DMA controller and so forth, and in addition to this, includes an A/D converter for receiving analog signals, an input/output control circuit for receiving input digital signals such as key manipulation signals and infrared signals (the on/off information of the foot switches SW1 to SW4) and giving the output digital signals to external devices, an internal memory, and so on.

The CPU executes the control program stored in the external memory 22. The digital signal from the A/D converter and the digital signal from the input/output control circuit are given to the CPU, and then the CPU executes necessary operation in accordance with these signals based on the control program. The graphics processor applies graphics processing required by the operation result of the CPU to the image data stored in the external memory 22 to generate a video signal corresponding to a picture to be displayed on the television monitor 5. The sound processor applies sound processing required by the operation result of the CPU to the sound data stored in the external memory 22 to generate an audio signal corresponding to music and sound effect. For example, the internal memory is a RAM, and is used as a working area, a counter area, a register area, a temporary data area, a flag area and/or the like area.

FIG. 3 is a flowchart showing the process flow which is executed by the processor 20 of FIG. 2. Referring to FIG. 3, when a power switch (not shown in the figure) of the adapter 1 is turned on, the power supply voltage is supplied to the processor 20, and the processor 20 performs the initialization process of the system in step S1. In step S3, the processor 20 performs processing in accordance with the application program stored in the external memory 22. In step S5, the processor 20 waits until an interrupt based on a video system synchronous signal is generated. In other words, if the interrupt based on the video system synchronous signal is not generated, the processing of the processor 20 repeats the same step S5. If the interrupt based on the video system synchronous signal is generated, the processing thereof proceeds to step S7. For example, the interrupt based on the video system synchronous signal is generated at 1/60 second intervals. In step S7 and step S9, the processor 20 performs the process of updating the screen displayed on the television monitor 100 and the process of reproducing sound in synchronization with the interrupt. Then, the process of the processor 20 returns to step S3.

Also, the processor 20 captures the infrared ray signal (the on/off information of the foot switches SW1 to SW4) which the IR receiver 30 receives from the IR emitting unit 30 when the interrupt is generated (step S11).

The application program which controls the processing of step 3 includes a plurality of programs. One of these programs is a program which executes a time-measurement process. The time-measurement process will be preliminarily described referring to the flow chart because of common usage in each mode as described below.

FIG. 4 is a flowchart showing the time-measurement process which is one of the processes to be executed in step S3 of FIG. 3. Referring to FIG. 4, in step S20, the processor 20 increases a value of a counter C by one. Incidentally, it is assumed that the counter C is initialized to 0 in step S1 of FIG. 3. In step S22, the processor 20 determines whether or not the other program issues an instruction for stopping measuring time, the process proceeds to step S20 to continue to count if it is not issued, conversely the counting is finished to proceed to step S24 if it is issued. In step S24, the processor 20 assigns a value obtained by multiplying the value of the counter C by 1/60 seconds to a time-measurement value T. As described above, in the case where the interrupt based on the video system synchronous signal is generated at 1/60 second intervals, since the increment of the value of the counter C is performed every 1/60 seconds, the value of the counter C is converted into time by such operation. While the process for counting up is described in the above explanation, in the case where the process for counting down is executed, a predetermined value is preliminarily assigned to a variable C in the initialization process, and then decrement processing is performed in step S20.

Next, thirteen measurement modes of the mat system in accordance with the present embodiment will be described.

[Hangtime Measurement Mode]

FIG. 5 is a view for showing an example of a ready screen in the hangtime measurement mode in accordance with the embodiment. FIG. 6 is a view for showing an example of a during-measurement screen in the hangtime measurement mode in accordance with the embodiment. As shown in FIG. 5, the processor 20 displays the ready screen on the television monitor 5. The ready screen includes a mat object 200 imitating the mat 2. Also, the mat object 200 includes areas A1, A2, A3 and A4 corresponding to the step areas ST1, ST2, ST3 and ST4 of the mat 2 respectively. First, the processor 20 changes a color of the areas A2 and A3 of the mat object 200 corresponding to the step areas ST2 and ST3 of the mat 2 into a first predetermined color (hatched areas from bottom left to top right) , e.g., yellow so as to indicate the step areas ST2 and ST3 where the test subject must get upon.

Also, When the test subject steps on the step area(s) of the mat 2 to turn on the corresponding foot switch(es), the processor 20 changes the color of the corresponding area(s) of the mat object 200 into a second predetermined color (hatched areas from top left to bottom right of FIGS. 9, 13, 15, 16, 23, 25, 27, 31, 35 and 41 as described below) , e.g., blue. For this reason, when the test subject steps on the step areas ST2 and ST3 of the mat 2 in response to the instruction of the screen to turn on the corresponding foot switches SW2 and SW3, the processor 20 changes the color of the corresponding areas A2 and A3 of the mat object 200 into the second predetermined color.

When the test subject gets upon the step areas ST2 and ST3 and then jumps, the foot switches SW2 and SW3 transit from the ON state to the OFF state. The processor 20 starts to measure time from the point of time when both the switches SW2 and SW3 are turned off. As shown in FIG. 6, from then on, the processor 20 displays elapsed time, which changes every moment, in real time on the time display section 70 of the during-measurement screen. Then, the processor 20 stops measuring the time at the point of time when at least one of the foot switches SW2 and SW3 is turned off. Accordingly, the time from the point of time when both the switches SW2 and SW3 are turned off to the point of time when at least one of them is turned on, i.e., the hangtime of the test subject is displayed in the time display section 70.

As described above, the processor 20 measures the hangtime of the test subject. Especially, the hangtime as measured in such a manner is a criterion for evaluating instantaneous force (a faculty of exerting force rapidly) of the test subject. Besides, the hangtime as measured is also a criterion for evaluating walking ability and ability to concentrate.

If the test subject repeatedly performs such measurement, it is expected that such functions as the instantaneous force, the walking ability, and the ability to concentrate are improved. That is, it is expected that integrated capability of the whole body is improved and the ability to concentrate is brought up in addition to improvement of muscular strength of legs. In this way, this mat system not only measures these faculties but the mat system also can contribute to the improvement thereof.

By the way, as described above, when the test subject steps on the step area of the mat 2 to turn on the corresponding foot switch, the processor 20 changes the color of the corresponding area (Al to A4) of the mat object 200 into the second predetermined color (the processing of indicating a stepped position). Each mode as described below also executes the processing for indicating the stepped position in common.

FIG. 7 is a flowchart showing the processing of indicating the stepped position which is one of the processes to be executed in step S3 of FIG. 3. In this case, it is assumed that the color of each area (A1 to A4) of the mat object 200 is white in the case where the corresponding foot switch (SW1 to SW4) is turned off. Then, the color of each area (A1 to A4) changes to the blue when the corresponding foot switch (SW1 to SW4) is turned on.

Referring to FIG. 7, in step S1000, the processor 20 determines whether or not the foot switch SW1 is turned on, the process proceeds to step S1002 if ON, conversely the process proceeds to step S1004 if OFF. In step S1002, the processor 20 sets the color of the area A1 to the blue. On the other hand, in step S1004, the processor 20 sets the color of the area A1 to the white. In step S1006 after step S1002 or S1004, the processor 20 determines whether or not the foot switch SW2 is turned on, the process proceeds to step S1008 if ON, conversely the process proceeds to step S1010 if OFF. In step S1008, the processor 20 sets the color of the area A2 to the blue. On the other hand, in step S1010, the processor 20 sets the color of the area A2 to the white.

Instep S1012 after step S1008 or S1010, the processor 20 determines whether or not the foot switch SW3 is turned on, the process proceeds to step S1014 if ON, conversely the process proceeds to step S1016 if OFF. In step S1014, the processor 20 sets the color of the area A3 to the blue. On the other hand, in step S1016, the processor 20 sets the color of the area A3 to the white. In step S1018 after step S1014 or S1016, the processor 20 determines whether or not the foot switch SW4 is turned on, the process proceeds to step S1020 if ON, conversely the process proceeds to step S1022 if OFF. In step S1020, the processor 20 sets the color of the area A4 to the blue. On the other hand, in step S1022, the processor 20 sets the color of the area A4 to the white. After step S1020 or S1022, the process returns to the routine of FIG. 3.

Returning to FIG. 3, in step S7, the processor 20 displays each area A1 to A4 of the mat object 200 in the color set in the process of FIG. 7.

Next, processing for measuring the hangtime will be described referring to a flow chart. The processing for measuring the hangtime is actually performed by the application program of FIG. 3. For this reason, various processes are executed and the displayed screen is updated in synchronization with the interrupt based on the video system synchronous signal (step S7). However, in the following flow chart, the processing of the processor 20 is shown based on a viewpoint of the test subject so as to facilitate understanding. Accordingly, the update of the screen is shown in time series (in series). In this point, the same is true for various flow charts as described below.

FIG. 8 is a flowchart showing the processing for measuring the hangtime which is executed by the processor 20 of FIG. 2. Referring to FIG. 8, in step S30, the processor 20 initializes variables and flags to be used in this processing. In step S32, the processor 20 displays the ready screen of FIG. 5. In step S34, the processor 20 checks whether or not both the foot switches SW2 and SW3 are transited from OFF to ON. Then, the process of the processor 20 returns to step S34 if NO, conversely the process proceeds to step S36 if YES. In step S36, the processor 20 displays a measurement start screen (not shown in the figure). This screen includes letters which instructs the test subject to jump.

In step S38, the processor 20 checks whether or not both the foot switches SW2 and SW3 are transited from ON to OFF. Then, the process of the processor 20 returns to step S38 if NO, conversely the process proceeds to step S40 if YES. The case of “YES” means that both feet of the test subject are put off the mat 2, i.e., the test subject jumps. Accordingly, the processor 20 starts to measure the time (count up) in step S40, and simultaneously starts to display the time-measurement value T in real time in the time display section 70 in step S42.

In step S44, the processor 20 determines whether or not either or both of the foot switches SW2 and SW3 is turned on. The process of the processor 20 proceeds to step S50 if NO, conversely the process proceeds to step S46 if YES. The processor 20 stops measuring time in step S46, and displays the result screen including the time-measurement value T in subsequent step S48. The time-measurement value T corresponds to the hangtime of the test subject.

On the other hand, in step S50, the processor 20 determines whether or not 5 seconds elapse after starting to measure the time. Then, the process of the processor 20 returns to step S44 if NO, conversely the process proceeds to step S52 if YES. The processor 20 stops measuring time in step S52, and returns to step S30 after performing display indicating an error in step S54. In this way, when either or both of the foot switches SW2 and SW3 is not turned on within 5 seconds after starting to measure the time, it is determined that the operation is the error.

[Flight Rate Measurement Mode]

FIG. 9 is a view for showing an example of a during-measurement screen in the flight rate measurement mode in accordance with the embodiment. FIG. 10 is a view for showing an example of a measuring result screen in the flight rate measurement mode in accordance with the embodiment.

First, the processor 20 displays the same ready screen as that of FIG. 5 on the television monitor 5 (such letter string to be displayed as a title and so on is matched with the mode). Then, when the test subject gets upon the step areas ST2 and ST3 of the mat 2 and then jumps, the processor 20 displays the during-measurement screen of FIG. 9 on the television monitor 5 from the point of time when both the foot switches SW2 and SW3 are turned off. The test subject jumps in the step areas ST2 and ST3 by a predetermined number of times. In the present embodiment, the predetermined number of times is 10 times. However, since the first jump is not measured, the test subject jumps total of 11 times.

The processor 20 regards the time from the point of time when both the foot switches SW2 and SW3 are turned off to the point of time when at least one of them is turned on as the hangtime. In this point, it is the same as the hangtime measurement mode. On the other hand, the processor 20 regards the time from the point of time when at least one of the foot switches SW2 and SW3 is turned on to the point of time when both of them are turned off as a ground contact time. The set of the ground contact state and the subsequent flight state is regarded as one jump. Accordingly, the processor 20 starts measuring the ground contact time and the hangtime from the end point of the flight state of the first jump (the jump which is not measured), i.e., the start point of the second jump (the jump which is first measured). The end point of the flight state is the point of time when at least one of the switches SW2 and SW3 is turned on from the state where both of them are turned off.

The processor 20 displays a bar 76 whose length corresponds to the ground contact time as measured (a hatched area from top left to bottom right) (e.g., red) on an axis 80 of a flight/ground time display section 72 in real time. Also, the processor 20 displays a bar 74 whose length corresponds to the hangtime as measured (a hatched area from bottom left to top right) (e.g., blue) on the axis 80 of the flight/ground time display section 72 in real time. Two graduations of the axis 80 represent one jump. One graduation corresponds to the ground contact state and the subsequent one graduation corresponds to the flight state. Incidentally, the bar 76 extends downward from the axis 80, and the bar 74 extends upward from the axis 80. Also, the processor 20 displays a cursor 78 (a black portion) on the axis 80 so as to indicate the current state of the test subject. In the example of the figure, the finish of the sixth jump, i.e., the finish of the fifth jump to be measured is shown.

When the processor 20 detects 10 jumps to be measured, i.e., detects the 10 times of the transition from the OFF state of both the switches SW2 and SW3 to the ON state of at least one of them, as shown in FIG. 10, the processor 20 displays an average hangtime and an average ground contact time in the flight/ground average time display section 82 of the measuring result screen, and simultaneously displays the flight rate in the flight rate display section 84. The average hangtime which the processor 20 calculates is an average value of the 10 times of the hangtime. The average ground contact time which the processor 20 calculates is an average value of the 10 times of the ground contact time. The flight rate is given by dividing the average hangtime by the sum of the average hangtime and the average ground contact time. The symbol “/”is used to designate division.

In this way, the processor 20 measures the flight rate of the test subject. Especially, the flight rate measured in such a manner is a criterion for evaluating response muscular force of the test subject, i.e., ability which efficiently draws spring of muscle and sinew in the short ground contact time. Besides, the flight rate as measured is also a criterion for evaluating reflexes, walking ability, rhythmic sense, and ability to concentrate.

If the test subject repeatedly performs such measurement, it is expected that such functions as the response muscular force, the reflexes, the walking ability, the rhythmic sense, and the ability to concentrate are improved. That is, it is expected that successive motor performance is improved and the stability ability to concentrate in daily life is brought up by enhancing instantaneous force by enhancement of response of muscle and simultaneously enhancing a motion control function. In this way, this mat system not only measures these faculties but the mat system also can contribute to the improvement thereof.

Next, the process for measuring the flight rate will be described referring to the flowchart.

FIGS. 11 and 12 are flowcharts showing respectively the first half part and the last half part of the processing for measuring the flight rate which is executed by the processor 20 of FIG. 2. Referring to FIG. 11, in step S70, the processor 20 initializes variables and flags to be used in this processing. In step S72, the processor 20 displays a ready screen. In step S74, the processor 20 checks whether or not both the foot switches SW2 and SW3 is transited from OFF to ON. Then, the process of the processor 20 returns to step S74 if NO, conversely the process proceeds to step S76 if YES. In step S76, the processor 20 displays a measurement start screen (not shown in the figure). This screen includes letters which instructs the test subject to jump successively.

In step S78, the processor 20 checks whether or not both the foot switches SW2 and SW3 is transited from ON to OFF. Then, the process of the processor 20 returns to step S78 if NO, conversely the process proceeds to step S79 if YES. The case of “YES” means that both feet of the test subject are put off the mat 2, i.e., the test subject jumps. This jump corresponds to the first jump which is not used to measure the flight rate. Then, the processor 20 displays the during-measurement screen of FIG. 9 in step S79, and simultaneously starts to measure the hangtime in step S80.

In step S82, the processor 20 determines whether or not either or both of the foot switches SW2 and SW3 is turned on. The process of the processor 20 proceeds to step S86 if NO, conversely the process proceeds to step S84 if YES. The processor 20 stops measuring the hangtime and clears the counted value T in step S84, and then proceeds to step S94 of FIG. 12.

On the other hand, in step S86, the processor 20 determines whether or not 5 seconds elapse after starting to measure the time. Then, the process of the processor 20 returns to step S82 if NO, conversely the process proceeds to step S88 if YES. The processor 20 stops measuring the time in step S88, and returns to step S70 after performing display indicating an error in step S90. In this way, when either or both of the foot switches SW2 and SW3 is not turned on within 5 seconds after starting to measure the time, it is determined that the operation is the error.

Referring to FIG. 12, in step S94, the processor 20 starts to measure the ground contact time. In step S96, the processor 20 checks whether or not both the foot switches SW2 and SW3 is transited from ON to OFF. Then, the process of the processor 20 proceeds to step S118 if NO, conversely the process proceeds to step S98 if YES. The case of “YES” means that both feet of the test subject are put off the mat 2, i.e., the test subject jumps.

The processor 20 stops measuring the ground contact time, stores the counted value T and then clears the counted value T in step S98, and then proceeds to step S100. In step S100, the processor 20 displays the bar 76 whose length corresponds to the ground contact time as stored in step S98 in the ground contact time display section 72. The bar 76 is displayed on the horizontal axis which designates a value of a jump counter Cas described below.

On the other hand, in step S118, the processor 20 determines whether or not 4 seconds elapse after starting to measure the ground contact time. Then, the process of the processor 20 returns to step S96 if NO, conversely the process proceeds to step S120 if YES. The processor 20 stops measuring the time in step S120, and returns to step S70 after performing display indicating an error in step S122. In this way, when both of the foot switches SW2 and SW3 are not turned off within 4 seconds after starting to measure the time, it is determined that the operation is the error.

In step S102 after step S100, the processor 20 starts measuring the hangtime. In step S104, the processor 20 determines whether or not either or both of the foot switches SW2 and SW3 is turned on. The process of the processor 20 proceeds to step S124 if NO, conversely the process proceeds to step S106 if YES. The processor 20 stops measuring the ground contact time, stores the counted value T and then clears the counted value T in step S106, and then proceeds to step S108. In step S108, the processor 20 displays the bar 74 whose length corresponds to the hangtime as stored in step S106 in the ground contact time display section 72. The bar 74 is displayed on the horizontal axis which designates a value of the jump counter C_{J} as described below.

If “YES” is determined in steps S96 and S104, it is determined that one jump is finished, then in step S109, the processor 20 increments the jump counter Cⱼ by one, which indicates the number of times of jumps. In step S110, the processor 20 determines whether or not the value of the counter C_{J} is equal to 10, if NO, the process returns to step S94, conversely if YES, the process proceeds to step S112.

On the other hand, in step S124, the processor 20 determines whether or not 5 seconds elapse after starting to measure the hangtime. Then, the process of the processor 20 returns to step S104 if NO, conversely the process proceeds to step S126 if YES. The processor 20 stops measuring the time in step S126, and returns to step S70 after performing display indicating an error in step S128. The reason is the same as steps S86 to S90.

In step S112 after determining “YES” in step S110, the processor 20 calculates an average of the ground contact time stored in step S98, i.e. , an average ground contact time, and an average of the hangtime stored in step S106, i.e., an average hangtime. In step S114, the processor 20 calculates the flight rate based on the average hangtime and the average ground contact time obtained in step S112. Then, in step S116, the processor 20 displays the result screen of FIG. 10.

[Agility Measurement Mode]

In this mode, the test subject put a chair in front of the center of the mat2. Then, the test subject sits on the edge of the chair with arms lowered widthwise. On the other hand, the processor 20 displays the same ready screen as that of FIG. 5 on the television monitor 5 (such letter string to be displayed as a title and so on is matched with the mode). Then, the test subject steps by a predetermined number of steps (in the present embodiment, 50 steps) on the step areas ST2 and ST3 of the mat 2 while sitting. As the result, the foot switches SW2 and SW3 repeat ON and OFF alternately.

The processor 20 regards a transition from OFF to ON of the one foot switch as one step. In this case, when the transition from OFF to ON of the foot switch SW2 is regarded as one step, the processor 20 regards the transition from OFF to ON of the foot switches SW3 as the next one step. Conversely, when the transition from OFF to ON of the foot switch SW3 is regarded as one step, the processor 20 regards the transition from OFF to ON of the foot switches SW2 as the next one step. That is, even if the transition from OFF to ON of the same foot switch occurs successively, only the first transition from OFF to ON is regarded as the one step.

FIG. 13 is a view for showing an example of a during-measurement screen in the agility measurement mode in accordance with the embodiment. When the test subject starts to step on the step areas ST2 and ST3 while sitting, the processor 20 displays the during-measurement screen of FIG. 13 on the television monitor 5. The during-measurement screen includes a remaining step number display section 86 and an elapse time display section 88. The processor 20 displays the remaining step number to be performed by the test subject, i.e., (50—the current step number) in real time in the remaining step number section 86. Also, the processor 20 starts to measure time from a point of time at which the first step is detected, and displays elapsed time in the elapse time display section 88. Then, the processor 20 stops measuring the time at a point of time at which the fiftieth step is finished. As the result, the elapse time display section 88 displays finally the time taken by the test subject for stepping by the fifty steps.

In this way, the processor 20 measures the time taken by the test subject for stepping by the 50 steps. Since the test subject tries to step as fast as possible, especially, the time as measured in such a manner is a criterion for evaluating the agility (a faculty of acting quickly) of the test subject. Also, the time as measured is also a criterion for evaluating the instantaneous force and reflexes.

If the test subject repeatedly performs such measurement, it is expected that such functions as the agility, the instantaneous force, and the reflexes are improved. That is, it is expected that the reflexes is brought up and simultaneously the ability to concentrate in daily life is improved by bringing up the agility and the cooperativeness of both legs. In this way, this mat system not only measures these faculties but the mat system also can contribute to the improvement thereof .

Next, the process for measuring the agility will be described referring to a flowchart.

FIG. 14 is a flowchart showing the processing for measuring the agility which is executed by the processor 20 of FIG. 2. Referring to FIG. 14, in step S140, the processor 20 initializes variables and flags to be used in this processing. In step S142, the processor 20 displays a ready screen. In step S144, the processor 20 checks whether or not the transitions from OFF to ON of both the switches SW2 and SW3 occur. Then, the processor 20 returns to step S144 if NO, conversely proceeds to step S146 if YES. In step S146, the processor 20 starts to count down and simultaneously displays a measurement start screen (not shown in the figure) which indicates the progression of the countdown. In step S148, the processor 20 determines whether or not a counted value is 0, the process returns to step S148 if it is not 0, conversely the process proceeds to step S150 if it is 0.

The processor 20 starts to measure time in step S150, and simultaneously starts to display a measured value T in real time in the elapse time display section 88 in step S152. In step S154, the processor 20 determines whether or not 30 seconds elapse after starting to measure the time, the process proceeds to step S178 if YES, conversely the process proceeds to step S156 if NO.

In step S156, the processor 20 checks whether or not the transition from OFF to ON of the foot switch SW2 occurs. Then, the processor 20 returns to step S154 if NO, conversely proceeds to step S158 if YES. The case of “YES” means that the test subject lifts the left foot from the step area ST2 and then puts down the left foot on the step area ST2. Accordingly, in step S158, the processor 20 increases a counter C_{S} by one, which counts the number of steps of the test subject. In step 5160, the processor 20 computes the remaining number R_{S} of steps, i.e., 50−C_{S}. Then, in step S162, the processor 20 displays the remaining number R_{S} of steps in the remaining step number display section 86.

In step S164, the processor 20 determines whether or not 30 seconds elapse after starting to measure the time in step S150, the process proceeds to step S182 if YES, conversely the process proceeds to step S166 if NO.

In step S166, the processor 20 checks whether or not the transition from OFF to ON of the foot switch SW3 occurs. Then, the processor 20 returns to step S164 if NO, conversely proceeds to step S168 if YES. The case of “YES” means that the test subject lifts the right foot from the step area ST3 and then puts down the right foot on the step area ST3. Accordingly, in step S168, the processor 20 increases the counter C_{S} by one. In step S170, the processor 20 computes the remaining number R_{S} of steps, i.e., 50−C_{S}. Then, in step S172, the processor 20 displays the remaining number R_{S} of steps in the remaining step number display section 86.

In step S174, the processor 20 determines whether or not the remaining number R_{S} of steps is 0, the process proceeds to step S176 if it is 0, conversely the process returns to step S154 if it is not 0. The processor 20 stops measuring the time in step S176, and displays the result screen including the final measured value T in step S178.

In step S178 after determining “YES” in step S154, the processor 20 stops measuring the time, and returns to step S140 after performing display indicating an error in step S180. Also, in step S182 after determining “YES” in step S164, the processor 20 stops measuring the time, and returns to step S140 after performing display indicating an error in step S184. The processing of these steps S154, S178, S180, S164, S182 and S184 is a process for deciding to be an error when the test subject does not finish 50 steps within 30 seconds after starting to measure the time in step S150.

[Rhythmic Sense Measurement Mode]

FIG. 15 is a view for showing an example of a rhythm guide screen in the rhythmic sense measurement mode in accordance with the embodiment. FIG. 16 is a view for showing an example of a during-measurement screen in the rhythmic sense measurement mode in accordance with the embodiment. FIG. 17 is a view for showing an example of a measuring result screen in the rhythmic sense measurement mode in accordance with the embodiment.

First, the processor 20 displays the same ready screen as that of FIG. 5 on the television monitor 5 (such letter string to be displayed as a title and so on is matched with the mode). Then, the test subject gets upon the step areas ST2 and ST3 of the mat 2. The processor 20 displays a signal of starting and subsequently displays the rhythm guide screen as shown in FIG. 15. That is, the processor 20 displays the guide object 90 directly on the areas A2 and A3 of the mat object 200 alternately at a predetermined time interval Tg. In addition, the processor 20 outputs predetermined sound (guide sound) with the display of the guide object 90. That is, the processor 20 outputs the guide sound at the predetermined time interval Tg as if it were a metronome. The test subject recognizes rhythm (tempo) of required stepping while stepping in accordance with the guide object 90 displayed alternately and the alternate guide sound. Also, the processor 20 displays the elapse time gauge 105, which indicates the elapsed time from the time at which the display of the guide object 90 is started, by the change of color (shaded area). The full length of the elapse time gauge 105 indicates a period when a guide is made by the guide object 90.

When the total frequency of the display of the guide object 90 in right and left reaches predetermined times, the processor 20 ends to display the guide object 90, and to output the guide sound, and then displays the during-measurement screen of FIG. 16. In this during-measurement screen, the guide object 90 is not displayed, and the guide sound is not also output. Accordingly, the test subject steps continuously under such condition with the rhythm (tempo) which he/she recognizes by the rhythm guide screen. In the present embodiment, after ending to display the guide object 90, it is instructed the test subject to perform the 20 steps of the stepping. The method for deciding one step is the same as that of the agility measurement mode. The processor 20 displays the remaining step number to be performed by the test subject, i.e., (20—the current step number) in real time in the remaining step number section 86.

During this during-measurement screen is displayed, the processor 20 performs the processing for determining whether or not the test subject steps at the predetermined time interval Tg indicated by the guide object 90 and the guide sound. More specific description is as follows.

The processor 20 measures a time (hereinafter referred to as “step interval”) Ts from the detection of one step to the detection of the next one step. That is, the processor 20 measures the step interval Ts, which is a time from when the transition from OFF to ON of one of the foot switches SW2 and SW3 is detected to when the transition from OFF to ON of the other one is detected. Incidentally, the processor 20 starts to measure from when the first one step is detected after ending to display the last guide object 90. That is, the first one step is regarded as the zeroth step, the next step is regarded as the first step, and a time period therebetween is regarded as the step interval Ts of the first step.

The processor 20 performs the processing for measuring the step interval Ts each time one step is detected, and stores the result in the internal memory to acquire data of 20 steps. Then, the processor 20 calculates the difference D=Tg−Ts. That is, the processor 20 calculates the extent to which the respective step intervals Ts differ from the predetermined time interval Tg indicated by the rhythm guide screen. Then, the processor 20 displays the result on the television monitor 5 as shown in FIG. 17. Specifically, the processor 20 displays the difference D with bars 98 and 100 on the axis 95 of the difference display section 96 of the measuring result screen. That is, when the difference D is positive, the processor 20 displays the bar 98 (shaded area in the oblique direction to the upper right) (e.g., red) having the length corresponding to the absolute value of the difference D in real time so as to extend upward from the axis 95. When the difference D is negative, the processor 20 displays the bar 100 (shaded area in the oblique direction to the lower right) (e.g., blue) having the length corresponding to the absolute value of the difference D in real time so as to extend downward from the axis 95. In this case, when the difference D is 0, these bars 98 and 100 are not displayed. One graduation of the axis 95 indicates one step.

Further, the processor 20 displays the rhythmic sense with a numeric value in the rhythmic sense display section 94. The numeric value is obtained based on a total amount of the absolute values of all the differences D. For example, it is assumed that a predetermined time x corresponds to one point, and that the points exceeding the five points are clipped to five points. Then, the total amount of the absolute values of the differences D is represented by the number of points, and the number of the points is subtracted from 100. The result is regarded as the numerical value indicating the rhythmic sense. That is, 100 points are given if the differences D concerning all of 20 steps are 0, and 0 point is given if the differences D concerning all of 20 steps are 5 points. In this case, it is preferred that the bars 98 and 100 whose length corresponds to the number of the points are displayed.

As described above, the processor 20 measurements the step interval Ts of the test subject to compute the difference D. The magnitude of the difference D is indicative whether or not the test subject can perform the stepping with the indicated rhythm (i.e., at the predetermined time interval Tg). As the result, especially, the difference D and the numerical value based thereon are a criterion for evaluating rhythmic sense (a sense to continue regular motion, i.e., isochronism) of the test subject. Also, the difference D and the numerical value based thereon are also a criterion for evaluating elaborateness, a faculty to memorize, and ability to concentrate.

If the test subject repeatedly performs such measurement, it is expected that such functions as the rhythmic sense, the elaborateness, the faculty to memorize, and the ability to concentrate are improved. That is, it is expected that a neurological function stabilizes by bringing up the balance in the right and left and the rhythmic sense, and simultaneously improving position sensation and a motion control function. In this way, this mat system not only measures these faculties but the mat system also can contribute to the improvement thereof.

FIGS. 18 and 19 are flowcharts showing respectively the first half part and the last half part of the processing for measuring the rhythmic sense which is executed by the processor 20 of FIG. 2. FIG. 20 is a flowchart showing the processing for measuring the step interval which is executed by the processor 20 of FIG. 2.

Referring to FIG. 18, in step S200, the processor 20 initializes variables and flags to be used in this processing. In step S202, the processor 20 displays a ready screen. In step S204, the processor 20 checks whether or not both the foot switches SW2 and SW3 are transited from OFF to ON. Then, the process of the processor 20 returns to step S204 if NO, conversely the process proceeds to step S206 if YES. In step S206, the processor 20 starts to count down and simultaneously displays a measurement start screen (not shown in the figure) which indicates the progression of the countdown. In step S208, the processor 20 determines whether or not the counted value is 0, the process returns to step S208 if it is not 0, conversely the process proceeds to step S210 if it is 0.

In step S210, the processor 20 starts to advance the elapse time gauge 105. In step S212, the processor 20 displays the left guide object 90 (directly on the area A2) and simultaneously performs one-shot playback of the guide sound. At the same time, in step S214, the processor 20 starts to measure time (T1). In step S216, the processor 20 determines whether or not the measured value T1 is equal to the predetermined time interval Tg, the process returns to step S216 if NO, conversely the process proceeds to step S218 if YES. The processor 20 deletes the left guide object 90 being displayed in step S218, clears the measured value T1 in step S220, and increases the counter C_{G}, which indicates the frequency of the display of the guide object 90, by one in step S222.

In step S224, the processor 20 displays the right guide object 90 (directly on the area A3) and simultaneously performs one-shot playback of the guide sound. At the same time, in step S226, the processor 20 starts to measure the time (T1). In step S228, the processor 20 determines whether or not the measured value T1 is equal to the predetermined time interval Tg, the process returns to step S228 if NO, conversely the process proceeds to step S230 if YES. The processor 20 deletes the right guide object 90 being displayed in step S230, clears the measured value T1 in step S232, and increases the counter C_{G} by one in step S234.

In step S236, the processor 20 determines whether or not the counter C_{G} is equal to 20, the process returns to step S212 if NO, conversely the process proceeds to step S238 of FIG. 19 if YES. Thereby, a total of 20 guide objects 90 is displayed in a right-left alternate manner.

Referring to FIG. 19, in step S238, the processor 20 displays the during-measurement screen of FIG. 16. In step S240, the processor 20 resets a counter Cᵤ (see FIG. 20), which indicates the number of steps of the test subject. In step S242, the processor 20 determines whether or not a measured value T2 (see FIG. 20) is more than or equal to 3 seconds, the process proceeds to step S244 if YES, conversely the process proceeds to step S246 if NO.

The processor 20 performs display indicating an error in step S244 after determining “YES” in step S242, and then returns to step S200. Since the measured value T2 indicates the step interval of the test subject, this processing is a process for deciding to be an error when 3 or more seconds elapse from the last step of the test subject during displaying the guide screen.

On the other hand, in step S246 after determining NO in step S242, the processor 20 determines whether or not the value of the counter C_{U} changes, the process returns to step S242 if NO, conversely the process proceeds to step S248 if YES. The change of the value of the counter Cᵤ indicates occurrence of the renewed step. Accordingly, in step S248, the processor 20 computes the remaining number R_{S} of steps, i.e., 20−C_{U}. Then, in step S250, the processor 20 displays the remaining number R_{S} of steps in the remaining step number display section 92.

In step S252, the step interval Tp (see FIG. 20) of the test subject is assigned to an element Ts[K] of an arrangement. That is, the element Ts[K] stores the step interval Tp of the (k+1)-th step. In step S254, the processor 20 increases a variable K by one. In step S256, the processor 20 determines whether or not the remaining number R_{S} of steps is 0, the process returns to step S242 if NO, conversely the process proceeds to step S258 if YES.

In step S258, the processor 20 assigns 0 to the variable K. In step S260, the processor 20 computes the difference between the predetermined interval Tg for the display of the guide object 90 and the step interval Ts[K] of the test subject to assign it to the element D[K] of an arrangement. That is, the element D[K] stores the difference between the predetermined interval Tg and the step interval Tp of the (K+1)-th step. Instep S262, the processor 20 increases the variable K. In step S264, the processor 20 determines whether or not the variable K is 19, the process proceeds to step S260 if NO, conversely the process proceeds to step S266 if YES. As the result, the differences between the predetermined interval Tg and the step interval Tp of 20 steps are assigned as the elements D[K] of the arrangement.

In step S266, the processor 20 selects the bar (reference 98 or 100) to be displayed in the difference display section 96 and decides the location thereof on the basis of a sign and an absolute value of each of the elements D[0] to D[19] of the arrangement. In step S268, the processor 20 computes the rhythmic sense to be displayed in the rhythmic sense display section 94 based on the absolute values of the elements D[0] to D[19] using the above method. Then, in step S270, the result screen of FIG. 17 is displayed.

Next, the processing for measuring the step interval of the test subject will be described.

FIG. 20 is the flowchart showing the processing for measuring the step interval which is executed by the processor 20 of FIG. 2. Referring to FIG. 20, in step S280, the processor 20 initializes variables and flags to be used in this processing. Then, in step S281, the processor 20 determines whether or not the counted value started in step S206 of FIG. 18 is 0, the process returns to step S281 if it is not 0, conversely the process proceeds to step S282 if it is 0.

In step S282, the processor 20 checks whether or not the transition from OFF to ON of one of the foot switches SW2 and SW3 occurs. Then, the processor 20 returns to step S282 if NO, conversely proceeds to step S284 if YES.

In step S284, the processor 20 clears the measured value T2 for measuring the step interval Tp of the test subject. In step S286, the processor 20 starts measuring the time (T2). In step S288, the processor 20 checks whether or not the transition from OFF to ON of the other one of the foot switches SW2 and SW3 occurs. Then, the processor 20 returns to step S288 if NO, conversely proceeds to step S290 if YES. In step S290, the processor 20 increases the counter C_{U}, which counts the number of steps of the test subject, by one. Instep S292, the processor 20 assigns the time measured value T2 to the variable Tp. Accordingly, the variable Tp stores a time from when the one of the foot switches SW2 and SW3 transits from OFF to ON to when the other one transits from OFF to ON, i.e., the time of one step with one leg.

In step S294, the processor 20 clears the time measured value T2. In step S296, the processor 20 starts to measure the time (T2). In step S298, the processor 20 checks whether or not the transition from OFF to ON of the above one of the foot switches SW2 and SW3 occurs. Then, the processor 20 returns to step S298 if NO, conversely proceeds to step S300 if YES. In step S300, the processor 20 increases the counter C_{U} by one. In step S302, the processor 20 assigns the time measured value T2 to the variable Tp. Accordingly, the variable Tp stores a time from when the above other one of the foot switches SW2 and SW3 transits from OFF to ON to when the one transits from OFF to ON, i.e., the time of one step with the other leg. Then, the process proceeds to step S284.

Subsequently, the processing of steps 5284 to 5302 is repeated, and whereby the interval of one step of one leg of the test subject and the interval of one step of the other leg are alternately and successively measured.

[Biological Clock Measurement Mode]

FIG. 21 is a view for showing an example of a ready screen in the biological clock measurement mode in accordance with the embodiment. First, the processor 20 displays the ready screen of FIG. 21 on the television monitor 5. This ready screen includes such letter string as “Count 15 seconds, and then jump”. Also, the processor 20 colors the areas A2 and A3 of the mat object 200 corresponding to the step areas ST2 and ST3 of the mat 2 a first predetermined color (hatched areas from bottom left to top right) so as to indicate the areas A2 and A3 where the test subject must get upon.

When the test subject gets upon the step areas ST2 and ST3 of the mat 2, i.e., the foot switches SW2 and SW3 are turned on, although not shown in the figure, the processor 20 displays such counting down as “3”, “2”, “1”, and “start” on the television monitor 5. The test subject jumps when he/she believes that 15 seconds elapse with own sense of self after such the letter string as “start” is displayed. In this case, the processor 20 starts to measure time at a point of time at which the letter string “start” is displayed. Then, the processor 20 stops measuring the time at a point of time at which all the foot switches SW1 to SW4 are turned off.

The time measured by the processor 20 indicates 15 seconds based on the biological clock of the test subject, and therefore it is possible to evaluate accuracy of the biological clock (mechanism for measuring time, which a person has in a body) of the test subject by obtaining the difference between the time-measurement result and 15 seconds. Also, the difference is a criterion for evaluating such functions of the test subject as the rhythmic sense, the judgment, and the ability to concentrate. Incidentally, rate of an error is obtained by dividing the difference by 15 seconds, and is also a criterion of the determination.

If the test subject repeatedly performs such measurement, it is expected that such functions as the biological clock, the rhythmic sense, the judgment, and the ability to concentrate are improved. That is, it is expected that sense of a certain time is brought up.

FIG. 22 is the flowchart showing the processing for measuring the biological clock which is executed by the processor 20 of FIG. 2. Referring to FIG. 22, in step S320, the processor 20 initializes variables and flags to be used in this processing. In step S322, the processor 20 displays the ready screen of FIG. 21. In step S324, the processor 20 checks whether or not the transitions from OFF to ON of both the switches SW2 and SW3 occur. Then, the processor 20 returns to step S324 if NO, conversely proceeds to step S326 if YES. In step S326, the processor 20 starts to count down and simultaneously displays a measurement start screen (not shown in the figure) which indicates the progression of the countdown. In step S328, the processor 20 determines whether or not the counted value is 0, the process returns to step S328 if it is not 0, conversely the process proceeds to step S330 if it is 0.

In step S330, the processor 20 starts to measure time and simultaneously displays the word “start”. In step S332, the processor 20 determines whether or not 30 seconds elapse after starting to measure the time, the process proceeds to step S338 if YES, conversely the process proceeds to step S334 if NO.

In step S334, the processor 20 checks whether or not the transitions from OFF to ON of both the switches SW2 and SW3 occur. Then, the processor 20 returns to step S332 if NO, conversely proceeds to step S335 if YES. The case of “YES” means that the test subject jumps. Then, in step S335, the processor 20 stops measuring the time. In step S336, the processor 20 displays the final time-measurement value T, i.e., the true time corresponding to 15 seconds under the biological clock of the test subject.

The processor 20 stops measuring the time in step S338 after determining “YES” in step S332, and returns to step S320 after performing display indicating an error in step S340. The processing is a process for deciding to be an error when the test subject does not jump within 30 seconds after starting to measure the time in step S330.

[Body Reflection Measurement Mode]

In this mode, the test subject put a chair in front of the center of the mat2. Then, the test subject sits on the edge of the chair with arms lowered widthwise.

On the other hand, the processor 20 displays the same ready screen as that of FIG. 5 on the television monitor 5 (such letter string to be displayed as a title and so on is matched with the mode). When the test subject stamps the step areas ST2 and ST3 of the mat 2 to turn on the foot switches SW2 and SW3, the processor 20 displays the signal of the start and then a during-measurement screen. Incidentally, the test subject removes both legs from the mat 2 after turning on the foot switches SW2 and SW3 to wait.

FIG. 23 is a view for showing an example of the during-measurement screen in the body reflection measurement mode in accordance with the embodiment. As shown in FIG. 23, the processor 20 displays a stamp position indicating object 113 directly on any one of the areas A1, A2, A3 and A4. The test subject tries to stamp the step area (ST1 to ST4) corresponding to the area (A1 to A4) directly under the stamp position indicating object 113 as fast as possible. In this case, the processor 20 starts to measure time from a point of time at which the stamp position indicating object 113 is displayed, and stops measuring the time at a point of time at which the transition from OFF to ON of the foot switch (SW1 to SW4) corresponding to the area (A1 to A4) directly under the stamp position indicating object 113 as displayed is detected. A time (unit reflection time) is a criterion for evaluating how quickly the test subject can respond to the display of the stamp position indicating object 113. The time (unit reflection time) is a time from when the stamp position indicating object 113 is displayed to when the transition from OFF to ON of the corresponding foot switch is detected.

When the transition from OFF to ON of the corresponding foot switch is detected, the processor 20 deletes the stamp position indicating object 113, then displays the renewed stamp position indicating object 113 directly on any one of the areas A1, A2, A3 and A4, starts measuring the time again, and stops measuring the time when the transition from OFF to ON of the foot switch (SW1 to SW4) corresponding to the area (A1 to A4) directly under the stamp position indicating object 113 as displayed is detected.

The processor 20 repeats such processing until the stamp position indication object is displayed 20 times. That is, the processor 20 stops measuring the time when the twentieth stamp position indicating object 113 is displayed and the transition from OFF to ON of the corresponding foot switch is detected.

The processor 20 displays the remaining number of steps to be performed by the test subject, i.e., (20−the current step number) in real time in the remaining step number display section 109, and displays the result of the time measurement in real time in the elapse time display section 111. Accordingly, the final result of the time measurement displayed in the elapse time display section 111 is the result of the accumulation of the unit reflection times. The final result of the time measurement is a criterion for evaluating the extent to which the test subject can quickly respond to the appearance of the stamp position indicating object 113, i.e., the extent of reflexes of the test subject. As the test subject responds more quickly, the final result of the time measurement is shorter. Also, the final result of the time measurement is also a criterion for evaluating the agility, the judgment, and the ability to concentrate.

If the test subject repeatedly performs such measurement, it is expected that such functions as the reflexes, the agility, the judgment, and the ability to concentrate. That is, it is expected that the judgment and the response is brought up, and simultaneously that the reflexes of the legs are improved. It is expected that the improvement of these function contributes to the reflection of nerves, such as a quick change of direction in usual day.

FIG. 24 is a flowchart showing the first half part of the processing for measuring the body reflection which is executed by the processor 20 of FIG. 2. Referring to FIG. 24, in step S360, the processor 20 initializes variables and flags to be used in this processing. In step S362, the processor 20 displays a ready screen. In step S364, the processor 20 checks whether or not the transitions from OFF to ON of both the switches SW2 and SW3 occur. Then, the processor 20 returns to step S364 if NO, conversely proceeds to step S366 if YES. In step S366, the processor 20 starts to count down and simultaneously displays a measurement start screen (not shown in the figure) which indicates the progression of the countdown. In step S368, the processor 20 determines whether or not the counted value is 0, the process returns to step S368 if it is not 0, conversely the process proceeds to step S370 if it is 0.

In step S370, the processor 20 starts to display the time-measurement value T in the elapse time display section 111 and the remaining number R_{S} of steps in the remaining step number display section 109 in real time. However, at this time, the time-measurement value T=0, and R_{S}=20. In step S372, the processor 20 generates a random number to select any one of the areas A1 to A4, and whereby the display location of the position indicating object 113 is decided. In step S374, the processor 20 determines whether or not the display location decided in step S372 is same as the previous display location, the process returns to step S372 if YES, conversely the process proceeds to step S376 if NO. In this way, it is possible to prevent displaying the position indicating object 113 at the same location continuously.

Then, in step S376, the processor 20 displays the position indicating object 113 directly on the area (any one of A1 to A4) selected in step S372. At the same time, in step S378, the processor 20 starts to measure time. In step S380, the processor 20 determines whether or not the foot switch (any one of SW1 to SW4) directly under the position indicating object 113 is transited from OFF to ON, the process returns to step S380 if NO, conversely the process proceeds to step S382 if YES. Accordingly, the process is not progressed next unless the test subject stamps the foot switch directly under the position indicating object 113.

In step S382, the processor 20 stops measuring the time temporarily. In step S384, the processor 20 computes the remaining number R_{S} of steps. In step S386, the processor 20 determines whether or not the remaining number R_{S} of steps is 0, the process proceeds to step S372 if NO, conversely the process proceeds to step S388 if YES. In this way, the processing of steps 5372 to 5386 is repeated until the position indicating object 113 is displayed 20 times. Then, in step S388, the processor 20 displays the result screen including the final result T of the time measurement.

[Body Response Measurement Mode]

FIG. 25 is a view for showing an example of a during-measurement screen in the body response measurement mode in accordance with the embodiment. First, the processor 20 displays the same ready screen as that of FIG. 5 on the television monitor 5 (such letter string to be displayed as a title and so on is matched with the mode). Then, when the test subject get upon the step areas ST2 and ST3 of the mat 2 to turn on the foot switches SW2 and SW3, the processor 20 displays the signal of the start and then the during-measurement screen of FIG. 25. That is, the processor 20 displays two guide object 119 directly on two of the areas A1, A2, A3 and A4 of the mat object 200 in the during-measurement screen. Also, the processor 20 starts to count down from 20 seconds simultaneously with the display of first two guide objects 119, and displays the result in real time in the remaining time display section 115. Incidentally, the test subject stamps by jumping in the state getting upon the mat 2.

The test subject tries to stamp by jumping the step areas (ST1 to ST4) corresponding to the areas (A1 to A4) directly under the two guide objects 119 as fast as possible. Then, the processor 20 deletes the two guide objects 119 and adds one point to display the number of points in a point display section 117 at a point of time at which the transition from OFF to ON of the foot switches (SW1 to SW4) corresponding to the areas (A1 to A4) directly under the two guide objects 119 is detected. Then, the processor 20 displays instantly the renewed two guide objects 119 directly on two of the areas A1, A2, A3 and A4, waits for the stamp of the test subject, and repeats the above processing until the remaining time is 0.

The number of points in the point display section 117 indicates the number of times of the responses of the test subject in 20 seconds. As a time from displaying two guide objects 119 until the test subject stamps the corresponding step areas (ST1 to ST4) is shorter, the number of points in the point display section 117 is larger. Accordingly, the number of points is a criterion for evaluating the extent to which the test subject can quickly respond to the two guide objects 119, i.e., the extent of reflexes of the test subject. Also, the number of points is a criterion for evaluating the instantaneous force, the walking ability, and the judgment.

If the test subject repeatedly performs such measurement, it is expected that such functions as the reflexes, the instantaneous force, the walking ability, and the judgment. That is, it is expected that it is possible to improve the faculty of judging what he/she looks at and simultaneously improve the faculty of linking the judgment to the action, and further improve the faculty of working muscle by an instruction given from a brain. For example, it is believed that these faculties contribute to prevention of a stumble when moving.

FIG. 26 is a flowchart showing the first half part of the processing for measuring the body response which is executed by the processor 20 of FIG. 2. Referring to FIG. 26, in step S400, the processor 20 initializes variables and flags to be used in this processing. In step S402, the processor 20 displays a ready screen.

In step S404, the processor 20 checks whether or not both the foot switches SW2 and SW3 are transited from OFF to ON. Then, the process of the processor 20 returns to step S404 if NO, conversely the process proceeds to step S406 if YES. In step S406, the processor 20 starts to count down and simultaneously displays a measurement start screen (not shown in the figure) which indicates the progression of the countdown. In step S408, the processor 20 determines whether or not the counted value is 0, the process returns to step S408 if it is not 0, conversely the process proceeds to step S409 if it is 0.

In step S409, the processor 20 starts to measure time (count down from 20 seconds). At the same time, in step S410, the processor 20 starts to display the time measurement value T in the remaining time display section 115 and the number P of points in the point display section 117 in real time. However, at the time, the time measurement value T=20, and P=0. In step S412, the processor 20 generates a random number to select one of four patterns. The locations of two guide objects 119 are indicated by the one pattern. The first pattern is a pattern of displaying the two guide objects 119 directly on the areas A2 and A3. The second pattern is a pattern of displaying the two guide objects 119 directly on the areas A2 and A4. The third pattern is a pattern of displaying the two guide objects 119 directly on the areas A1 and A3. The fourth pattern is a pattern of displaying the two guide objects 119 directly on the areas A1 and A4.

In step S414, the processor 20 determines whether or not the pattern selected in step S412 is the same as the previous selected pattern, the process returns to step S412 if YES, conversely the process proceeds to step S416 if NO. This prevents the guide objects 119 from being displayed continuously at the same location.

Then, in step S416, the processor 20 displays the two guide objects 119 in accordance with the pattern selected in step S412. In step S420, the processor 20 determines whether or not the two foot switches (two of SW1 to SW4) directly under the two guide objects 119 are transited from OFF to ON, the process returns to step S420 if NO, conversely the process proceeds to step S422 if YES. Accordingly, the process is not progressed next unless the test subject stamps the two foot switches directly under the two guide objects 119.

Instep S422, the processor 20 increases the points P by one. In step S424, the processor 20 determines whether or not the time measurement value T is 0, the process proceeds to step S412 if NO, conversely the process proceeds to step S426 if YES. In this way, the processing of steps 5412 to 5424 is repeated until 20 seconds elapse. Then, in step S426, the processor 20 displays the result screen including the final points P.

[Body Following Ability Measurement Mode]

FIG. 27 is a view for showing an example of a during-measurement screen in the body following ability measurement mode in accordance with the embodiment. First, the processor 20 displays the same ready screen as that of FIG. 5 on the television monitor 5 (such letter string to be displayed as a title and so on is matched with the mode). Then, when the test subject gets upon the step areas ST2 and ST3 of the mat 2 to turn on the foot switches SW2 and SW3, the processor 20 displays the signal of starting and/or outputs the sound of starting, and subsequently displays the during-measurement screen of FIG. 27. That is, the processor 20 moves the guide objects 135L and 135R cyclically in order of displaying the guide object 135R directly on the area A4, displaying the guide object 135L directly on the area A1, displaying the guide object 135R directly on the area A3, and displaying the guide object 135L directly on the area A2 as a starting point the guide objects 135L and 135R displayed directly on the areas A2 and A3. In this case, the processor 20 increases a moving counter MC by one each time the guide objects 135L and 135R move. Incidentally, the test subject steps in the state getting upon the mat 2.

Incidentally, when the guide object 135R moves directly on the area A4 from the starting point, next the guide object 135L moves directly on the area A1, next the guide object 135P moves directly on the area A3, and next the guide object 135L moves directly on the area A2, the process is defined as one cycle. Then, the processor 20 increases the moving velocities of the guide objects 135L and 135R in units of two cycles. That is, the level of a step velocity display section 131 is raised by one step. In the present embodiment, 25 levels are prepared.

The test subject tries to step on the step areas (ST1 to ST4) corresponding to the areas (A1 to A4) directly under the guide objects 135L and 135R in synchronization with the movement of the guide objects 135L and 135R. As described above, since the moving velocities of the guide objects 135L and 135R increase in incremental steps in units of two cycles, it is gradually difficult for the test subject to stamp in synchronization with the movement of the guide objects 135L and 135R.

Each time the transition from OFF to ON of the foot switch SW1 to SW4 is detected, the processor 20 increases the step counter SC by one to display the result in the step number display section 133. However, only when the transition from OFF to ON of the foot switch SW1 to SW4 occurs in the order indicated by the guide objects 135L and 135R, the step counter SC is increased. Then, the processor 20 computes the absolute value of the difference between the value of the moving counter MC and the value of the step counter SC, when the absolute value of the difference is more than or equal to 3, the processor 20 ends measuring.

The level in the step velocity display section 131 at a point of time at which the measurement finishes and the number of steps in the step number display section 133 at the point of time at which the measurement finishes are a criterion for evaluating the extent to which the test subject can follow to the movement of the guide objects 135L and 135R, i.e., the elaborateness of the test subject (the ability of controlling his/her own body at will). As the level in the step velocity display section 131 and the number of steps at the point of time at which the measurement finishes are larger, it is possible to follow to faster movement of the guide objects 135L and 135R. Also, the level in the step velocity display section 131 and the number of steps at the point of time at which the measurement finishes are a criterion for evaluating the walking ability, rhythmic sense, and the judgment.

If the test subject repeatedly performs such measurement, it is expected that such functions as the elaborateness, the walking ability, the rhythmic sense, and the judgment That is, it is expected that durability of reflexes and the dogged judgment are brought up.

Incidentally, needless to say, the any number of levels may be set. In this case, the level to which the target test subject can never follow may be set. On the other hand, the highest level is set to a level to which the target test subject can follow, by keeping the highest level after reaching the highest level, it is possible to have the test subject continue the following action. By adjusting the highest level at the time, it is possible to adjust amount of exercise to be performed by the test subject.

FIGS. 28 and 29 are flowcharts showing respectively the first half part and the last half part of the processing for measuring the body following ability which is executed by the processor 20 of FIG. 2. Referring to FIG. 28, in step S440, the processor 20 initializes variables and flags to be used in this processing. Instep S442, the processor 20 displays a ready screen. In step S444, the processor 20 checks whether or not both the foot switches SW2 and SW3 are transited from OFF to ON. Then, the process of the processor 20 returns to step S444 if NO, conversely the process proceeds to step S446 if YES. In step S446, the processor 20 starts to count down and simultaneously displays a measurement start screen (not shown in the figure) which indicates the progression of the countdown. In step S448, the processor 20 determines whether or not the counted value is 0, the process returns to step S448 if it is not 0, conversely the process proceeds to step S450 if it is 0.

In step S450, the processor 20 displays the velocity level according to the guide velocity (a prescribed time) Tv in the velocity display section 131. The guide velocity Tv indicates the time interval at which the locations of the guide objects 135L and 135R are switched, and the initial value thereof is the highest value. The velocity level corresponding to the highest level, i.e., the initial value of the velocity level is one. In step S452, the processor 20 displays the guide objects 135L and 135R directly on the areas A2 and A3 respectively. In step 5454, the processor 20 determines whether or not the prescribed time indicated by the guide velocity Tv elapses after the display in step S450, the process returns to step S454 if NO, conversely the process proceeds to step S456 of FIG. 29 if YES.

Referring to FIG. 29, in step S456, the processor 20 deletes the guide object 135R directly on the area A3, and displays the guide object 135R directly on the area A4. In step S458, the processor 20 increases the moving counter MC, which is counted up each time anyone of the guide objects 135L and 135R moves, by one. Then, in step S460, the processor 20 determines whether or not the prescribed time indicated by the guide velocity Tv elapses after the display in step S456, the process returns to step S460 if NO, conversely the process proceeds to step S462 if YES.

In step S462, the processor 20 deletes the guide object 135L directly on the area A2, and displays the guide object 135L directly on the area A1. In step S464, the processor 20 increases the moving counter MC by one. Then, in step S466, the processor 20 determines whether or not the prescribed time indicated by the guide velocity Tv elapses after the display in step S462, the process returns to step S466 if NO, conversely the process proceeds to step S468 if YES.

In step S468, the processor 20 deletes the guide object 135R directly on the area A4, and displays the guide object 135R directly on the area A3. In step S470, the processor 20 increases the moving counter MC by one. Then, in step S472, the processor 20 determines whether or not the prescribed time indicated by the guide velocity Tv elapses after the display in step S468, the process returns to step S472 if NO, conversely the process proceeds to step S474 if YES.

In step S474, the processor 20 deletes the guide object 135L directly on the area A1, and displays the guide object 135L directly on the area A2. In step S470, the processor 20 increases the moving counter MC by one. Then, in step S478, the processor 20 determines whether or not the prescribed time indicated by the guide velocity Tv elapses after the display in step S474, the process returns to step S478 if NO, conversely the process proceeds to step S480 if YES.

In step S480, the processor 20 determines whether or not a variable i is one, the process proceeds to step S486 if NO, conversely the process proceeds to step S482 if YES. The initial value of the variable i is 0, and the variable i repeats alternately 0 and 1 each time the cycle progresses (step S486). Accordingly, in the case where the variable i is not one, i.e., the variable i is zero, the case means that two cycles do not elapse, and therefore the process proceeds to step S486 so as to maintain the same velocity level. Then, in step S486, the processor 20 assigns one to the variable i, and then proceeds to step S456. On the other hand, in the case where the variable i is one, the case means that two cycles elapse, and therefore the process proceeds to step S482 so as to change the velocity level. Accordingly, in step S482, the processor 20 updates the guide velocity Tv to the shorter time. The updated value may be pulled out of a table, or obtained by subtracting from the value. Then, in step S484, the processor 20 increases the velocity level in the step velocity display section 131 by one. Subsequently, in step S486, the processor 20 assigns zero to the variable i to proceed to step S456.

Next, the processing for measuring the difference between the stepping of the test subject and the guide will be described.

FIG. 30 is a flowchart showing the processing for measuring the difference which is executed by the processor 20 of FIG. 2. Referring to FIG. 30, in step S490, the processor 20 initializes variables and flags to be used in this processing. Then, in step S492, the processor 20 determines whether or not the value of the count started in step S446 of FIG. 28 is 0, the process returns to step S492 if it is not 0, conversely the process proceeds to step S494 if it is 0.

In step S494, the processor 20 checks whether or not the foot switch SW4 is transited from OFF to ON. Then, the processor 20 returns to step S494 if NO, conversely proceeds to step S496 if YES.

The processor 20 increases the step counter SC for counting the number of steps of the test subject by one instep S496, and simultaneously updates the value of the step counter SC displayed in the step number display section 133 in step S498. In step S500, the processor 20 calculates the difference between the value of the moving counter MC and the value of the step counter SC, and assigns it to the variable MS. In step S502, the processor 20 determines whether or not the difference MS is more than or equal to 3, if YES, it is regarded as failure and the process proceeds to step S534, conversely the process proceeds to step S504 if NO.

In step S504, the processor 20 checks whether or not the foot switch SW1 is transited from OFF to ON. Then, the processor 20 returns to step S504 if NO, conversely proceeds to step S506 if YES.

The processor 20 increases the step counter SC by one in step S506, and simultaneously updates the value of the step counter SC displayed in the step number display section 133 in step S508. In step S510, the processor 20 calculates the absolute value of the difference between the value of the moving counter MC and the value of the step counter SC, and assigns it to the variable MS. In step S512, the processor 20 determines whether or not the difference MS is more than or equal to 3, if YES, it is regarded as failure and the process proceeds to step S534, conversely the process proceeds to step S514 if NO.

In step S514, the processor 20 checks whether or not the foot switch SW3 is transited from OFF to ON. Then, the processor 20 returns to step S514 if NO, conversely proceeds to step S516 if YES.

The processor 20 increases the step counter SC by one in step S516, and simultaneously updates the value of the step counter SC displayed in the step number display section 133 in step S518. In step S520, the processor 20 calculates the absolute value of the difference between the value of the moving counter MC and the value of the step counter SC, and assigns it to the variable MS. In step S522, the processor 20 determines whether or not the difference MS is more than or equal to 3, if YES, it is regarded as failure and the process proceeds to step S534, conversely the process proceeds to step S524 if NO.

In step S524, the processor 20 checks whether or not the foot switch SW2 is transited from OFF to ON. Then, the processor 20 returns to step S524 if NO, conversely proceeds to step S526 if YES.

The processor 20 increases the step counter SC by one in step S526, and simultaneously updates the value of the step counter SC displayed in the step number display section 133 in step S528. In step S530, the processor 20 calculates the absolute value of the difference between the value of the moving counter MC and the value of the step counter SC, and assigns it to the variable MS. In step S532, the processor 20 determines whether or not the difference MS is more than or equal to 3, if YES, it is regarded as failure and the process proceeds to step S534, conversely the process proceeds to step S494 if NO.

Subsequently, the processing of steps 5494 to 5532 is repeated to measure the difference MS between the stepping of the test subject and the guide in real time.

In step S534, the processor 20 displays the result screen including the final velocity level and the number of steps.

[First Judgment Measurement Mode]

In this mode, first, the processor 20 displays the same ready screen as that of FIG. 5 on the television monitor 5 (such letter string to be displayed as a title and so on is matched with the mode). When the test subject stamps the step areas ST2 and ST3 to turn on the foot switches SW2 and SW3, the processor 20 displays a signal of starting and then displays a measurement screen. Incidentally, the test subject removes both legs from the mat 2 after turning on the foot switches SW2 and SW3 to wait.

FIG. 31 is a view for showing an example of a measurement screen in the first judgment measurement mode in accordance with the embodiment. As shown in FIG. 31, the processor 20 displays drawing display sections 121-1, 121-2, 121-3 and 121-4 directly on the areas A1, A2, A3 and A4 of the mat object 200 in the measurement screen respectively (setting a task). The different drawings are displayed in the drawing display sections 121-1, 121-2, 121-3 and 121-4 respectively. In this case, one of the four drawings is different from a category of the other ones. In the example of the figure, insects are displayed in the drawing display section 121-1, 121-2 and 121-3, and a bird is displayed in the drawing display section 121-4. Incidentally, in the present embodiment, three task groups (three stages) are prepared. Also, the processor 20 displays an elapse time gauge 105 which indicates elapsed time with change of color (shaded area). The full length of the elapse time gauge 105 represents a time period (in the present embodiment, 20 seconds) given to the test subject so as to answer the one task group (one stage).

When the test subject stamps the step area (ST1 to ST4) corresponding to the area (A1 to A4) located directly under the drawing display section (121-1 to 121-4) in which the drawing belonging to the different category is displayed and whereby the corresponding foot switch (SW1 to SW4) is turned on, it is determined that the answer is correct and one point is added. When the test subject turns on the incorrect foot switch, it is determined that the answer is not correct and one point is subtracted. The test subject tries to arrive at the correct answers as many as possible until the color change of the elapse time gauge 105 is completed. The points during the 20 seconds are a criterion for evaluating the judgment of the test subject. As the points are higher, the judgment is higher. Also, the points are a criterion for evaluating the reflexes.

If the test subject repeatedly performs such measurement, it is expected that such functions as the judgment and the reflexes are improved. That is, it is expected that cognitive capability in the daily life is brought up to contribute to the improvement of flexibility of a brain and the prevention of the dementia.

FIG. 32 is a flowchart showing the processing of the first judgment measurement which is executed by the processor 20 of FIG. 2. Referring to FIG. 32, in step S550, the processor 20 initializes variables and flags to be used in this processing. In step S552, the processor 20 displays a ready screen. In step S553, the processor 20 checks whether or not both the foot switches SW2 and SW3 are transited from OFF to ON. Then, the process of the processor 20 returns to step S553 if NO, conversely the process proceeds to step S554 if YES. In step S554, the processor 20 starts to count down and simultaneously displays a measurement start screen (not shown in the figure) which indicates the progression of the countdown. In step S556, the processor 20 determines whether or not the counted value is 0, the process returns to step S556 if it is not 0, conversely the process proceeds to step S558 if it is 0.

The processor 20 stats to measure time in step S558 and simultaneously stats to advance the elapse time gauge 105 in step S560. In step S562, the processor 20 decides a task to be set. In step S564, the processor 20 displays the task decided in step S562, i.e., the four drawings in the drawing display sections 121-1 to 121-4. In step S566, the processor 20 determines whether or not any one of the foot switches SW1 to SW4 is transited from OFF to ON, the process returns to step S566 if NO, conversely the process proceeds to step S568 if YES. In step S568, the processor 20 deletes the four drawings being displayed from the drawing display sections 121-1 to 121-4.

In step S570, the processor 20 determines whether the foot switch which transits from OFF to ON indicates the correct answer, the process proceeds to step S574 if NO, conversely the process proceeds to step S572 if YES. In step S574, the processor 20 decreases the points P by one. On the other hand, in step S572, the processor 20 increases the points P by one.

In step S576, the processor 20 determines whether or not 20 seconds elapse from when the time measurement is started in step S558, i.e., the present stage is finished, the process proceeds to step S562 if NO, conversely the process proceeds to step S578 if YES. In step S578, the processor 20 determines whether or not all stages, i.e., the three stages are finished, the process proceeds to step S580 if NO, conversely the process proceeds to step S582 if YES. In step S580, the processor 20 clears the elapse time gauge 105 and the measured value T, and simultaneously updates the stage by one, and then proceeds to step S558. On the other hand, in step S582, the processor 20 displays the result screen including the final points P.

Next, the processing of step S562 will be described in detail for each stage. First, the task decision process in the first stage will be described.

FIG. 33 is a flowchart showing the task decision process (the first stage) in step S562 of FIG. 32. Referring to FIG. 33, in step S584, the processor 20 generates a random number to select one group as the first group from thirteen groups. The each group consists of different four drawings. For example, a sea conveyance, an air conveyance, a four-wheeled vehicle, a two-wheeled vehicle, an insect, a bird, a land animal, a fish, an industrial tool, a medical device (including medicine), a cooking tool, sporting equipment, and an electrical appliance are assigned to thirteen groups respectively.

In step S585, the processor 20 determines whether or not the first group selected in step S584 is the same as the previous first group, the process returns to step S584 if YES, conversely the process proceeds to step S586 if NO. In step S586, the processor 20 generates a random number to select one group as the second group from thirteen groups. In step S587, the processor 20 determines whether or not the second group selected in step S586 is the same as the latest first group, the process returns to step S586 if YES, conversely the process proceeds to step S588 if NO.

In step S588, the processor 20 generates a random number to select one drawing from the first group. In step S589, the processor 20 generates a random number to select one drawing from the second group. In step S590, the processor 20 decides the position of the one drawing selected from the second group based on a random number. That is, one of the drawing display sections 121-1 to 121-4 is selected based on the random number. In step S591, the processor 20 assigns the position of the one drawing selected from the first group to the remaining three positions. Returning to FIG. 32, in step S564, the processor 20 displays the four drawings at the positions decided in this way. Accordingly, in the first stage, the different drawing is displayed only in any one of the drawing display sections 121-1 to 121-4. Thus, the test subject tries to select the different one drawing quickly.

Next, the task decision process in the second stage will be described. This processing is the same as the processing of FIG. 33. However, six groups are prepared. The each group consists of four drawings different from one another. For example, an alpha-numeral, a numeral represented by a dice, a numeral represented by a playing card, a numeral represented by matchsticks, a numeral represented by cubes, and a Chinese numeral are assigned to the six groups respectively. In the second stage, the drawing representing the different numeral is displayed only in any one of the drawing display sections 121-1 to 121-4. Thus, the test subject tries to select the one drawing representing the different numeral quickly.

Further next, the task decision process in the third stage will be described.

FIG. 34 is a flowchart showing the task decision process (the third stage) in step S562 of FIG. 32. Referring to FIG. 34, in step S592, the processor 20 generates a random number to select one group as the first group from the same thirteen groups as the first stage.

In step S593, the processor 20 determines whether or not the first group selected in step S592 is the same as the previous first group, the process returns to step S593 if YES, conversely the process proceeds to step S594 if NO. In step S594, the processor 20 generates a random number to select one group as the second group from the thirteen groups. In step S595, the processor 20 determines whether or not the second group selected in step S594 is the same as the latest first group, the process returns to step S594 if YES, conversely the process proceeds to step S596 if NO.

In step S596, the processor 20 generates a random number to select one drawing to be subtracted from the first group. In step S597, the processor 20 generates a random number to select one drawing to be added to the first group from the second group. In step S598, the processor 20 generates a random number among 0 to 23 to decide the arrangement of four drawings. That is, the four drawings are assigned to the drawing display sections 121-1 to 121-4. These four drawings are the three drawings remaining in step S596 and the one drawing selected in step S597. Returning to FIG. 32, in step S564, the processor 20 displays the four drawings at the positions decided in this way. Accordingly, in the third stage, the drawing belonging to the different group is displayed only in any one of the drawing display sections 121-1 to 121-4. Thus, the test subject tries to select the different one drawing quickly.

[Second Judgment Measurement Mode]

In this mode, first, the same ready screen as that of FIG. 5 (such letter string to be displayed as a title and so on is matched with the mode) is displayed on the television monitor 5. This ready screen includes letter string “Lift a leg of a position indicating a lager numeral”. Also, the processor 20 colors the areas A2 and A3 of the mat object 200 corresponding to the step areas ST2 and ST3 of the mat 2 a first predetermined color (hatched areas from bottom left to top right) so as to indicate the step areas ST2 and ST3 where the test subject must get upon. When the test subject gets upon the step areas ST2 and ST3 of the mat 2, i.e., the foot switches SW2 and SW3 are turned on, the processor 20 displays a measurement screen after displaying a signal of starting. Incidentally, the test subject performs the stepping in the state getting upon the mat 2.

FIG. 35 is a view for showing an example of a measurement screen in the second judgment measurement mode in accordance with the embodiment. Referring to FIG. 35, the processor 20 displays numeral display sections 123L and 123R directly on the areas A2 and A3 respectively. The different numerals from each other are displayed in the numeral display sections 123L and 123R (setting a task). The test subject lifts the leg from the step area (ST2 or ST3) corresponding to the area (A2 or A3) directly under the numeral display section (123L or 123R) in which the larger numeral is contained and whereby changes the corresponding foot switch (SW2 or SW3) from ON to OFF. In this case, the test subject has to get the correct answer before the color change of the elapse time gauge 105 is completed. Incidentally, in the present embodiment, the color change of the elapse time gauge 105 is completed in one second.

When the color change of the elapse time gauge 105 is completed, the processor 20 undoes the color of the elapse time gauge 105, and simultaneously displays the renewed numerals different from each other in the numeral display sections 123L and 123R respectively. In response, the test subject answers before the color change of the elapse time gauge 105 is completed in the same manner as the above.

When the 10 tasks are finished, the processor 20 displays a ready screen including letter string “Lift a leg of a position representing a smaller numeral”. Then, the processor 20 displays a signal of starting, and subsequently displays the same measurement screen as that of FIG. 35. The test subject lifts the leg from the step area (ST2 or ST3) corresponding to the area (A2 or A3) directly under the numeral display section (123L or 123R) in which the smaller numeral is contained and whereby changes the corresponding foot switch (SW2 or SW3) from ON to OFF. In this case, the test subject has to get the correct answer before the color change of the elapse time gauge 105 is completed.

When the 10 tasks are finished, the processor 20 displays a ready screen including letter string “Lift a leg of a position representing a larger numeral”. Then, the processor 20 displays a signal of starting, and subsequently displays the same measurement screen as that of FIG. 35. In response, the test subject answers before the color change of the elapse time gauge 105 is completed in the same manner as the above.

The processor 20 repeats the selection of the larger numeral and the selection of the smaller numeral alternately in units of 10 tasks as described above, and finishes if the tasks are a total of 100 tasks. However, when the test subject gets incorrect answer, the measurement is finished at the time. The processor 20 displays how many answers among 100 tasks are correct. The number of the correct answers is a criterion for evaluating the judgment of the test subject. As the number of the correct answers is greater, the judgment is higher. Also, the number of the correct answers is a criterion for evaluating the reflexes.

If the test subject repeatedly performs such measurement, it is expected that such functions as the judgment and the reflexes are improved. That is, it is expected that the reason faculty and the simplicity cognition are brought up, and certain simplicity reflexes are used continuously and whereby a nerve is stabilized to obtain relaxed feeling. It is believed that this is useful to retain calmness in daily life.

FIG. 36 is a flowchart showing the processing of the second judgment measurement which is executed by the processor 20 of FIG. 2. Referring to FIG. 36, in step S600, the processor 20 initializes variables and flags to be used in this processing. In step S602, the processor 20 displays a ready screen. In step S604, the processor 20 checks whether or not both the foot switches SW2 and SW3 are transited from OFF to ON. Then, the processor 20 returns to step S604 if NO, conversely proceeds to step S606 if YES. In step S606, the processor 20 starts to count down and simultaneously displays a measurement start screen (not shown in the figure) which indicates the progression of the countdown. In step S608, the processor 20 determines whether or not the counted value is 0, the process returns to step S608 if it is not 0, conversely the process proceeds to step S610 if it is 0.

In step S610, the processor 20 displays a task sentence (select the smaller numeral or select the larger numeral). In step S612, the processor 20 determines whether or not a predetermined time elapses, the process proceeds to step S612 if NO, conversely the process proceeds to step S614 if YES to delete the task sentence. In step S616, the processor 20 generates the random number to decide the task. The detail is as shown below.

The four groups are prepared. Each group consists of six drawings. The first group consists of the six drawings each of which represents an alpha-numeral among 1 to 6. The second group consists of the six drawings each of which represents a numeral among 1 to 6 using a dice. The third group consists of the six drawings each of which represents a numeral among 1 to 6 using a playing card. The fourth group consists of the six drawings each of which represents a Chinese numeral among 1 to 6. Also, it is assumed that the first to tenth tasks, the eleventh to twentieth tasks, the twenty-first to thirtieth questions, the thirty-first to fortieth tasks, the forty-first to fiftieth tasks, the fifty-first to sixtieth tasks, the sixty-first to eightieth tasks, and the eighty-first to hundredth tasks correspond to the first stage, the second stage, the third stage, the fourth stage, the fifth stage, the sixth stage, the seventh stage, and the eighth stage respectively.

In the first stage, a random number is generated to select two different drawings from the first group. In the second stage, a random number is generated to select one drawing from the first group and further a random number is generated to select one drawing representing the different numeral from the numeral represented by the one drawing selected from the first group from the second group. Incidentally, the process of selecting from the second group is performed until the different numeral from the numeral selected from the first group is selected.

In the third stage, a random number is generated to select one drawing from the first group and further a random number is generated to select one drawing representing the different numeral from the numeral represented by the one drawing selected from the first group from the third group. Incidentally, the process of selecting from the third group is performed until the different numeral from the numeral selected from the first group is selected. In the fourth stage, a random numbers is generated to select two different drawings from the second group.

In the fifth stage, a random number is generated to select one drawing from the second group and further a random number is generated to select one drawing representing the different numeral from the numeral represented by the one drawing selected from the second group from the third group. Incidentally, the process of selecting from the third group is performed until the different numeral from the numeral selected from the first group is selected. In the sixth stage, a random numbers is generated to select two different drawings from the third group.

In the seventh stage, a random number is generated to select one group from the first to the third groups. Further, a random number is generated to select one group from the first to the third groups. The selection process is performed until the different group from the group which is previously selected is selected. Then, a random number is generated to select one drawing from the group which is previously selected. Next, a random number is generated to select one drawing representing the different numeral from the numeral selected from the group which is previously selected from the group which is selected later. The selection process is performed until the different numeral from the numeral which is previously selected is selected.

In the eighth stage, a random number is generated to select one group from the first to the fourth groups. Further, a random number is generated to select one group from the first to the fourth groups. The selection process is performed until the different group from the group which is previously selected is selected. Then, a random number is generated to select one drawing from the group which is previously selected. Next, a random number is generated to select one drawing representing the different numeral from the numeral selected from the group which is previously selected from the group which is selected later. The selection process is performed until the different numeral from the numeral which is previously selected is selected.

Referring to FIG. 36, in step S618, the processor 20 stats to advance the elapse time gauge 105 and simultaneously displays the two drawings selected in step S616 in the numeral display sections 123L and 123R respectively. In step S620, the processor 20 determines whether or not one second elapses after displaying the task of step S616, the process proceeds to step S638 if YES, conversely the process proceeds to step S622 if NO.

In step S622, the processor 20 determines whether or not any one of the foot switches SW2 and SW3 is transited from OFF to ON, the process proceeds to step S620 if NO, conversely the process proceeds to step S624 if YES. In step S624, the processor 20 determines whether or not the foot switch which transits from OFF to ON indicates the correct answer, the process proceeds to step S638 if NO, conversely the process proceeds to step S626 if YES. In step S626, the processor 20 increases the number CA of the correct answers by one. In step S628, the processor 20 determines whether or not the current stage is finished, if NO, the process proceeds to step S630 to delete the drawings in the numeral display sections 123L and 123R and reset the elapse time gauge 105, and then proceeds to step S616.

On the other hand, when “YES” is determined in step S628, the process proceeds to step S632 to determine whether or not the finished stage is the final stage. The process proceeds to step S638 if YES, conversely the process proceeds to step S634 if NO. In step S638, the processor 20 displays the result screen including the number CA of the correct answers. On the other hand, in step S634, the processor 20 updates the stage. Then, in step S636, the processor 20 switches the task sentence and then proceeds to step S610.

[Third Judgment Measurement Mode]

In this mode, first, the same ready screen as that of FIG. 5 is displayed on the television monitor 5 (such letter string to be displayed as a title and so on is matched with the mode). This start screen includes the letter string “Jump when the right and left are the same”. Also, the processor 20 colors the areas A2 and A3 of the mat object 200 corresponding to the step areas ST2 and ST3 of the mat 2 a first predetermined color (hatched area from bottom left to top right) so as to indicate the step areas ST2 and ST3 where the test subject must get upon. When the test subject gets upon the step areas ST2 and ST3 of the mat 2, i.e., the foot switches SW2 and SW3 are turned on, the processor 20 displays a measurement screen after displaying a signal of starting. Incidentally, the test subject performs the stepping in the state getting upon the mat 2.

FIG. 37 is a view for showing an example of a measurement screen in the third judgment measurement mode in accordance with the embodiment. Referring to FIG. 37, the processor 20 displays a left object 125L and a right object 125R directly on the areas A2 and A3 respectively (setting a task). The left object 125L and the right object 125R include drawings representing numerals. When the numerals represented by the left object 125L and the right object 125R are equal to each other, the test subject jumps to turn the corresponding foot switches (SW2 and SW3) from ON to OFF. In this case, the test subject has to get the correct answer before the color change of the elapse time gauge 105 is completed.

When the color change of the elapse time gauge 105 is completed, the processor 20 undoes the color of the elapse time gauge 105, and simultaneously displays the renewed left object 125L and the renewed right object 125R. In response, the test subject answers before the color change of the elapse time gauge 105 is completed in the same manner as the above.

When 10 tasks are finished, the processor 20 displays a ready screen including the letter string “Jump when the right and left are different from each other”. Then, the processor 20 displays a signal of starting, and subsequently displays the same measurement screen as that of FIG. 37. When the numerals represented by the left object 125L and the right object 125R are different from each other, the test subject jumps to turn the corresponding foot switches (SW2 and SW3) from ON to OFF. In this case, the test subject has to get the correct answer before the color change of the elapse time gauge 105 is completed.

The processor 20 repeats the answer method of jumping when right and left coincide with each other and the answer method of jumping when right and left differ from each other alternately in units of 10 tasks as described above, and finishes if the tasks are a total of 30 tasks. The processor 20 shortens a time when the color change of the elapse time gauge 105 is completed, i.e., an answer time given to the test subject each time one task is finished. In the present embodiment, the answer time is shortened by a predetermined percentage so that it is begun with 3 seconds of the first task and then is progressed to 0.5 seconds of the thirtieth task Finally, the processor 20 displays how many answers among 30 tasks are correct (a correct answer rate). The correct answer rate is a criterion for evaluating the judgment and the restraint of the test subject. As the correct answer rate is higher, the judgment and the restraint are higher. Also, the correct answer rate is a criterion for evaluating the instantaneous force, the reflexes, and the agility.

If the test subject repeatedly performs such measurement, it is expected that such functions as the restraint, the judgment, the instantaneous force, the reflexes, and the agility are improved. That is, it is expected that the judgment and the restraint on motion are brought up, and further that the flexibility of the judgment, the ability for carrying out an instruction, and the ability for judging the situation concerning the action as performed. Also, it is believed that a sophisticated motor nervous system in daily life is improved

FIG. 38 is a flowchart showing the processing of the third judgment measurement which is executed by the processor 20 of FIG. 2. Referring to FIG. 38, in step S650, the processor 20 initializes variables and flags to be used in this processing. In step S652, the processor 20 displays a ready screen. In step S654, the processor 20 checks whether or not the transitions from OFF to ON of both the switches SW2 and SW3 occur. Then, the processor 20 returns to step S654 if NO, conversely proceeds to step S656 if YES. In step S656, the processor 20 starts to count down and simultaneously displays a measurement start screen (not shown in the figure) which indicates the progression of the countdown. In step S658, the processor 20 determines whether or not the counted value is 0, the process returns to step S658 if it is not 0, conversely the process proceeds to step S660 if it is 0.

In step S660, the processor 20 displays the task sentence (jump when the same or jump when the discrepancy). In step S662, the processor 20 determines whether or not a certain time elapses, the process proceeds to step S662 if NO, conversely the process proceeds to step S664 if YES to delete the task sentence. Instep S666, the processor 20 generates the random number to decide the task. The detail is as shown below. One of numerals 1 to 9 is selected by generating a random number. Further more, one of numerals 1 to 9 is selected by generating a random number. As the result, the two numerals are selected.

In step S668, the processor 20 starts to advance the elapse time gauge 105, and simultaneously displays the left object 125L and the right object 125R which respectively indicate the one numeral decided in step S666 and the other numeral decided in step S666. In step S670, the processor 20 determines whether or not T_{A} seconds elapse after displaying the task of step S668, the process proceeds to step S674 if YES, conversely the process proceeds to step S672 if NO.

In step S672, the processor 20 determines whether or not the answer is correct based on the input of the test subject, and then proceeds to step S674. In step S674, the processor 20 determines whether or not the current stage is finished, if NO, the process proceeds to step S676 to delete the left object 125L and the right object 125R and reset the elapse time gauge 105, and then proceeds to step S666.

On the other hand, when “YES” is determined in step S674, in step S678, it is determined whether or not the finished stage is the final stage, the process proceeds to step S684 if YES, conversely the process proceeds to step S680 if NO. In step S684, the processor 20 displays the result screen including the number CA of the correct answers. On the other hand, in step S680, the processor 20 updates the stage. Then, in step S682, the processor 20 switches the task sentence and updates the time T_{A}, and then proceeds to step S660. Incidentally, the time T_{A} is set to a shorter value every update.

FIG. 39 is a flowchart showing the processing for determining right and wrong in step S672 of FIG. 35. Referring to FIG. 39, in step S700, the processor 20 proceeds to step S702 if the task sentence is “Jump when the right and left are the same”, otherwise, i.e., if the task sentence is “Jump when the right and left are different from each other”, the process proceeds to step S710.

In step S702, the processor 20 determines whether or not the task elements, i.e., the left object 125L and the right object 125R indicate the same numeral, the process proceeds to step S704 if YES, conversely the process proceeds to step S708 if NO. In step S704, the processor 20 checks whether or not both the foot switches SW2 and SW3 are transited from ON to OFF, the process proceeds to step S670 of FIG. 38 if NO, conversely the process proceeds to step S706 if YES. In the case where the task sentence is “Jump when the right and left are the same” and further more the two numerals are the same, this process is a process for determining that the answer is correct only when both the foot switches SW3 and SW4 are turned off. In this way, tense feeling of the test subject can be raised. Instep S706, the number CA of the correct answers increases by one, and then the process returns.

On the other hand, if “NO” is determined in step S702, i.e., the left object 125L and the right object 125R indicate the numerals different from each other, the process proceeds to step S708. In step S708, the processor 20 checks whether or not at least one of the foot switches SW2 and SW3 is transited from ON to OFF, the process returns if YES, conversely the process proceeds to step S670 of FIG. 38 if NO, i.e., both the foot switches SW2 and SW3 maintain ON. In the case where the task sentence is “Jump when the right and left are the same” and further more the two numerals are different from each other, this process is a process for determining that the answer is incorrect immediately when any one of the foot switches SW3 and SW4 is turned off. In this way, tense feeling of the test subject can be raised.

On the other hand, if it is determined in step S700 that the task sentence is “Jump when the right and left are different from each other”, in step S710, the processor 20 determines whether or not the task elements, i.e., the left object 125L and the right object 125R indicate the numerals different from each other, the process proceeds to step S712 if YES, conversely the process proceeds to step S716 if NO. In step S712, the processor 20 checks whether or not both the foot switches SW2 and SW3 are transited from OFF to ON, the process proceeds to step S670 of FIG. 38 if NO, conversely the process proceeds to step S714 if YES. In the case where the task sentence is “Jump when the right and left are different from each other” and further more the two numerals are different from each other, this process is a process for determining that the answer is correct only when both the foot switches SW3 and SW4 are turned off. In this way, tense feeling of the test subject can be raised. In step S714, the number CA of the correct answers increases by one, and then the process returns.

On the other hand, if “NO” is determined in step S710, i.e., the left object 125L and the right object 125R indicate the same numeral, the process proceeds to step S7716. In step S716, the processor 20 checks whether or not at least one of the foot switches SW2 and SW3 is transited from ON to OFF, the process returns if YES, conversely the process proceeds to step S670 of FIG. 38 if NO, i.e., both the foot switches SW2 and SW3 maintain ON. In the case where the task sentence is “Jump when the right and left are different from each other” and further more the two numerals are the same, this process is a process for determining that the answer is incorrect immediately when any one of the foot switches SW3 and SW4 is turned off. In this way, tense feeling of the test subject can be raised.

[Memory Measurement Mode]

In this mode, first, the processor 20 displays the same ready screen as that of FIG. 5 on the television monitor 5 (such letter string to be displayed as a title and so on is matched with the mode). When the test subject stamps the step areas ST2 and ST3 of the mat 2 to turn on the foot switches SW2 and SW3, the processor 20 displays the signal of the start and then a task screen. Incidentally, the test subject removes both legs from the mat 2 after turning on the foot switches SW2 and SW3 to wait.

FIG. 40 is a view for showing an example of the task screen in the memory measurement mode in accordance with the embodiment. As shown in FIG. 40, the processor 20 displays N (N is an integer of three or more) guide objects 127 above the mat object 200 of the task screen. Then, the guide objects 127 are changed to a predetermined color sequentially from the left in the figure at a certain time interval Tg. Each time the guide object 127 is changed to the predetermined color, the processor 20 displays a cursor 129 over any one of the areas A1 to A4 and immediately deletes it.

The test subject tries to memorize in what order the cursor 129 is displayed over the areas A1 to A4. Then, the test subject stamps the step area (ST1 to ST4) corresponding to the area (A1 to A4) in the memorized order while looking at the answer screen as displayed next. Incidentally, the processor 20 displays and deletes the cursor 129 by the same N times as the number N of the guide objects 127. As the result, the test subject can preliminarily realize from what number to what number the order to be memorized is present by the number N of the displayed guide objects.

FIG. 41 is a view for showing an example of the answer screen in the memory measurement mode in accordance with the embodiment. The processor 20 displays a signal of starting after finishing the task screen of FIG. 40, and subsequently displays the answer screen as shown in FIG. 40. The processor 20 displays an elapse time gauge 105 which indicates elapsed time with the change of the color (shaded area). The full length of the elapse time gauge 105 indicates an answer time given to the test subject. When the test subject stamps the step areas (ST1 to ST4) in the order shown by the cursor 129 until the color change of the elapse time gauge 105 is completed, it is cleared. If the step areas (ST1 to ST4) are stamped in the different order from the order shown by the cursor 129, the processor 20 regards as a failure at the time. Also, the same number N of the guide objects 127 as the number N of the guide objects 127 in the task screen are displayed in the answer screen, and are changed to the predetermined color in the same manner. Incidentally, a time period corresponding to the full length of the elapse time gauge 105 corresponds to a time from when the leftmost guide object in the figure is changed to the predetermined color to 0.5 seconds elapse after the rightmost guide object in the figure is changed to the predetermined color.

Besides, the number N, which is the number of the guide objects 127 in the task screen and answer screen, begins with three and increases by one each time the test subject clears the task (N←N+1). That is, the object to be memorized increases and whereby the degree of difficulty is raised. When the number N increases one, the time period Tg of the color change of the guide object 127 is also shortened.

In this case, if it is assumed that the current number of the guide objects 127 is referred as “n”, the order which the cursor 129 shows currently is obtained by adding one more position to be memorized to the order shown by the guide object 127 when the number of the guide objects is (n−1). That is, if it is assumed that the current number of the guide objects 127 is “n”, while the order to the n-th is indicated, the order to (n−1)-th does not change.

In this way, although the order from the first to the (n−1)-th does not change, the full order from the first to the n-th is shown each time the number of the guide objects 127 increases. This facilitates memory operation of the test subject at some level. In contrast, the next process may be applied so as to raise the degree of difficulty. That is, if it is assumed that the current number of the guide objects 127 is “n”, only the n-th to be anew added is indicated by the cursor 129. Accordingly, in this case, since the order to (n−1)-th is not shown again as described above, the degree of difficulty is raised. Incidentally, each time the number of the guide objects increases, the order different completely from the previous order may be shown. In this case, the full order is shown each time.

By the way, the number N of the guide objects 127 in the task screen which is finally cleared is a criterion for evaluating the extent of the memory of the test subject. As the number N of the guide objects 127 in the task screen which is finally cleared is larger, the memory of the test subject is better. Also, the final number N is also a criterion for evaluating the ability to concentrate.

If the test subject repeatedly performs such measurement, it is expected that such functions as the faculty to memorize and the ability to concentrate are improved. That is, it is expected that the short time memory and the response are brought up, and simultaneously that the durability of the determination and the ability to concentrate are brought up. Also, it is expected that forgetfulness is prevented and the body action response is brought up.

FIGS. 42 and 43 are flowcharts showing respectively the first half part and the last half part of the processing for measuring the memory which is executed by the processor 20 of FIG. 2. Referring to FIG. 42, in step S730, the processor 20 initializes variables and flags to be used in this processing. In step S732, the processor 20 displays a ready screen. In step S734, the processor 20 checks whether or not both the foot switches SW2 and SW3 are transited from OFF to ON. Then, the process of the processor 20 returns to step S734 if NO, conversely the process proceeds to step S736 if YES. In step S736, the processor 20 starts to count down and simultaneously displays a measurement start screen (not shown in the figure) which indicates the progression of the countdown. In step S738, the processor 20 determines whether or not the counted value is 0, the process returns to step S738 if it is not 0, conversely the process proceeds to step S740 if it is 0.

In step S740, the processor 20 displays the number N of the guide objects 127. In this case, the initial value of N is 3. In step S742, the processor 20 determines whether or not a certain time elapses, the process returns to step S742 if NO, conversely the process proceeds to step S744 if YES. In step S744, the processor 20 generates a random number to decide the display position of the cursor 129. That is, the random number is generated to select any one of the areas A1 to A4. In step S746, the processor 20 changes the color of the m-th guide object 127, and simultaneously displays the cursor 129 so that it overlaps with the area (A1 to A4) selected in step S744. Incidentally, the leftmost guide object 127 is zeroth, as the position is more right, the order of the guide objects 127 is larger.

In step S748, the processor 20 determines whether or not the certain time elapses, the process returns to step S748 if NO, conversely the process proceeds to step S750 if YES. In step S750, the processor 20 increases the variable “m” by one. In step S752, the processor 20 determines whether or not the variable “m” is equal to (N−1), the process returns to step S744 if NO, conversely the process proceeds to step S754 of FIG. 43 if YES.

Referring to FIG. 43, in step S754, the processor 20 assigns 0 to the variable “m”. In step S756, the processor 20 undoes the color of the number N of the guide objects 127. In step S758, the processor 20 starts to measure time and progress the elapse time gauge 105. In step S760, the processor 20 determines whether or not any one of the foot switches SW1 to SW4 is transited from OFF to ON, the process proceeds to step S772 if NO, conversely the process proceeds to step S762 if YES.

In step S762, the processor 20 determines whether or not the foot switch transited from OFF to ON indicates the position indicated in step S746, the process proceeds to step S774 if NO, conversely the process proceeds to step S764 if YES. In step S764, the processor 20 determines whether or not the variable “m” is equal to (N−1), the process proceeds to step S760 if NO, conversely the process proceeds to step S768 if YES. In step S768, the processor 20 increases the number N by one. In step S770, the processor 20 determines whether or not the number N is equal to 16, the process proceeds to step S740 of FIG. 42 if NO, conversely the process proceeds to step S774 if YES. In step S774, the processor 20 displays the result screen including the number N of the guide objects 127 in the task screen which is finally cleared.

In step S772 after determining “NO” in step S760, the processor 20 determines whether or not the certain time elapses, the process returns to step S760 if NO, conversely the process proceeds to step S774 if YES.

[Motor Performance Measurement Mode]

This mode simulates the so-called jump rope, in which two persons grip the ends of a rope to turn the rope, and then the other person jumps so as not to touch the rope.

In this mode, first, the processor 20 displays the same ready screen as that of FIG. 5 on the television monitor 5 (such letter string to be displayed as a title and so on is matched with the mode). When the test subject stamps the step areas ST2 and ST3 of the mat 2 to turn on the foot switches SW2 and SW3, the processor 20 displays the signal of the start and then the measurement screen as described blow. Incidentally, the test subject performs the mode in the state getting upon the step areas ST2 and ST3.

FIG. 44 is a view for showing an example of the measurement screen in the motor performance measurement mode in accordance with the embodiment. Referring to FIG. 44, this screen includes a counter 140, a character 142, and a rope object 144 which imitates a skipping rope. The processor 20 performs animation so that the character 142 turns the rope object 144 clockwise at a constant speed. Then, the test subject jumps at the timing when the rope object 144 reaches the lowest position (i.e., the six-hour direction). When the test subject is successful the jump, the processor 20 counts up the counter 140 by one. On the other hand, when the test subject misses the jump, the processor 20 performs the animation of the character 142 and the rope object 144 as if the test subject got tangled in the rope. Next, the detail of the process of determining the success and failure will be described.

In this system, the processor 20 updates a video frame at 1/60 second intervals. The 60 images for the rope object 144 are prepared. The processor 20 updates the image of the rope object 144 at 1/60 second intervals to generate video images as if a rope turned.

When the processor 20 detects the state where at least one of the foot switches SW1 to SW4 of the mat 2 is turned on during the period from when the rope object 144 reaches the topmost position (i.e., the twelve-hour direction) to when the rope object 144 reaches the right horizontal direction (i.e., the three-hour direction), the processor 20 determines either the success or failure, otherwise the processor 20 does not performs the processing for determining the success and failure. In this case, when the rope object 144 reaches the right horizontal direction (i.e., the three-hour direction), the processor 20 decides whether or not the processor 20 performs the processing for determining the success and the failure.

If the state in which all the switches SW1 to SW4 of the mat 2 are turned off is detected during a period from when the rope object 144 reaches the right horizontal direction (i.e., the three-hour direction) to when the rope object 144 reaches the lowest position (i.e., the six-hour direction), the processor 20 determines that the jump is successful, otherwise the processor 20 determines that the jump fails. In this case, the processor 20 issues a decision of the determination when the rope object 144 reaches the lowest position (i.e., the six-hour direction).

By the way, the counted value displayed in the counter 140, i.e., the number of the successful jumps of the test subject is a criterion for evaluating the extent of certain motor performance of the test subject. As the counted value is larger, the motor performance of the test subject is better. If the test subject repeatedly performs such measurement, it is expected that the motor performance is improved.

FIG. 45 is flowchart showing the processing for measuring the motor performance which is executed by the processor 20 of FIG. 2. Referring to FIG. 45, in step S800, the processor 20 initializes variables and flags to be used in this processing. In step S802, the processor 20 displays a ready screen. In step S804, the processor 20 checks whether or not both the foot switches SW2 and SW3 are transited from OFF to ON. Then, the process of the processor 20 returns to step

S804 if NO, conversely the process proceeds to step S806 if YES. In step S806, the processor 20 starts to count down and simultaneously displays a measurement start screen (not shown in the figure) which indicates the progression of the countdown. In step S808, the processor 20 determines whether or not the counted value is 0, the process returns to step S808 if it is not 0, conversely the process proceeds to step S810 if it is 0.

In step S810, the processor 20 starts an animation which turns the rope object 144 clockwise. In step S812, the processor 20 determines whether or not the rope object 144 is positioned between the twelve-hour direction and the three-hour direction, the process returns to step S812 if NO, conversely the process proceeds to step S814 if YES. In step S814, the processor 20 determines whether or not at least one of the foot switches SW1 to SW4 is turned on, the process proceeds to step S818 if NO, conversely the process proceeds to step S816 if YES. Instep S816, the processor 20 turns on a first flag, and then proceeds to step S818. The first flat indicates whether or not the process for determining the success and failure is executed. In step S818, the processor 20 determines whether or not the rope object 144 is positioned at the three-hour direction, the process returns to step S814 if NO, conversely the process proceeds to step S820 if YES.

In step S820, the processor 20 determines whether or not the first flag is turned on, if ON, i.e., if the process for determining the success and failure is executed, the process proceeds to step S822, conversely if OFF, the process proceeds to step S812. In step S822, the processor 20 determines whether or not all the foot switches SW1 to SW4 are turned off, the process proceeds to step S826 if NO, conversely the process proceeds to step S824 if YES. In step S824, the processor 20 turns on a second flag, and then proceeds to step S826. The second flag indicates the success of the jump.

In step S826, the processor 20 determines whether or not the rope object 144 is positioned at the six-hour direction, the process returns to step S822 if NO, conversely the process proceeds to step S828 if YES. In step S828, the processor 20 determines whether or not the second flag is turned on, the process proceeds to step S830 if YES, conversely the process proceeds to step S836 if NO. In step S830, the processor 20 turns off the first and second flags, and then proceeds to step S832. In step S832, a counter C_{J} is increased by one. The counter C_{J} indicates the number of times of the success, i.e., the number of times of the jumps. In step S834, the processor 20 displays the value of the counter C_{J}, and then proceeds to step S812. On the other hand, if NO is determined in step S828, i.e., if the failure, the processor 20 displays the animation which represents the failure in step S836.

Meanwhile, the present invention is not limited to the above embodiments, and a variety of variations and modifications may be effected without departing from the spirit and scope thereof, as described in the following exemplary modifications.

(1) It is assumed that the rhythm guide screen of FIG. 15 and the during-measurement screen of FIG. 16 make a set, in the rhythmic sense measurement mode, the plurality of the sets may be performed. In this case, the interval Tg of the appearance of the guide object 90, i.e., the tempo is changed for each set. Accordingly, the test subject has to step on the basis of the different tempo depending on the set. As the result, it is possible to raise the degree of the difficulty in comparison with the case where the tempo is the same among the sets.

(2) While the various indications are given to the test subject by the images as described above, the indication may be given together with the sound, or only by the sound.

(3) It is believed that the measurement objects in the hangtime measurement mode, the flight rate measurement mode, the agility measurement mode, the body reflection measurement mode, the body response measurement mode, the body following ability measurement mode, and the motor function measurement mode depend on the motor performance mainly. On the other hand, it is believed that the measurement objects in the first to the third judgment measurement modes, the memory measurement mode, the rhythmic sense measurement mode, and the biological clock measurement mode relates to the brain works more closely.

(4) In the above embodiment, the stepping, the jump, and so on of the test subject are detected by the foot switches SW1 to SW4 of the mat 2. However, the detecting method of the motion of the test subject is not limited to it. For, example, the motion may be detected by photographing the test subject with an imaging device, such as an image sensor and a CCD. In this case, it is preferred that a retroreflective sheet is attached to a subject. Also, for example, the step of the test subject may be detected by disposing a sensor at a base of footwear, such as sandals and shoes. In this case, various types of sensors may be employed. For example, a push switch, a simple mechanical type sensor, a pressure sensor, a membrane switch, or the like may be employed. Further, for example, the step of the test subject may be detected using a piezoelectric type acceleration sensor, an electrodynamic acceleration sensor, a strain gauge type acceleration sensor, or a semiconductor type acceleration sensor (MEMS: Micro Electro Mechanical Systems). In this case, a pedometer type detection unit, which has an acceleration sensor, may be used.

### BRIEF DESCRIPTION OF DRAWINGS

FIG. 1 is a block diagram showing the entire configuration of a mat system in accordance with an embodiment of the present invention.

FIG. 2 is a schematic diagram showing the electric configuration of a mat unit 7, an adapter 1, and a cartridge 3 of FIG. 1.

FIG. 3 is a flowchart showing the process flow which is executed by a processor 20 of FIG. 2.

FIG. 4 is a flowchart showing the process of measuring time which is one of the processes to be executed in step S3 of FIG. 3.

FIG. 5 is a view showing an example of a ready screen in a hangtime measurement mode in accordance with the embodiment.

FIG. 6 is a view for showing an example of a during-measurement screen in the hangtime measurement mode in accordance with the embodiment.

FIG. 7 is a flowchart showing the processing for indicating the stepped position which is one of the processes to be executed in step S3 of FIG. 3.

FIG. 8 is a flowchart showing the processing for measuring the hangtime which is executed by the processor 20 of FIG. 2.

FIG. 9 is a view for showing an example of a during-measurement screen in the flight rate measurement mode in accordance with the embodiment.

FIG. 10 is a view for showing an example of a measuring result screen in the flight rate measurement mode in accordance with the embodiment.

FIG. 11 is a flowchart showing the first half part of the processing for measuring the flight rate which is executed by the processor 20 of FIG. 2.

FIG. 12 is a flowchart showing the last half part of the processing for measuring the flight rate which is executed by the processor 20 of FIG. 2.

FIG. 13 is a view for showing an example of a during-measurement screen in the agility measurement mode in accordance with the embodiment.

FIG. 14 is a flowchart showing the last half part of the processing for measuring the agility which is executed by the processor 20 of FIG. 2.

FIG. 15 is a view for showing an example of a guide screen in the rhythmic sense measurement mode in accordance with the embodiment.

FIG. 16 is a view for showing an example of a during-measurement screen in the rhythmic sense measurement mode in accordance with the embodiment.

FIG. 17 is a view for showing an example of a measuring result screen in the rhythmic sense measurement mode in accordance with the embodiment.

FIG. 18 is a flowchart showing the first half part of the processing for measuring the rhythmic sense which is executed by the processor 20 of FIG. 2.

FIG. 19 is a flowchart showing the last half part of the processing for measuring the rhythmic sense which is executed by the processor 20 of FIG. 2.

FIG. 20 is a flowchart showing the processing for measuring the step interval which is executed by the processor 20 of FIG. 2.

FIG. 21 is a view for showing an example of a start screen in the biological clock measurement mode in accordance with the embodiment.

FIG. 22 is a flowchart showing the processing for measuring the biological clock which is executed by the processor 20 of FIG. 2.

FIG. 23 is a view for showing an example of a during-measurement screen in the body reflection measurement mode in accordance with the embodiment.

FIG. 24 is a flowchart showing the processing for measuring the body reflection which is executed by the processor 20 of FIG. 2.

FIG. 25 is a view for showing an example of a during-measurement screen in the body response measurement mode in accordance with the embodiment.

FIG. 26 is a flowchart showing the processing for measuring the body response which is executed by the processor 20 of FIG. 2.

FIG. 27 is a view for showing an example of a during-measurement screen in the body following ability measurement mode in accordance with the embodiment.

FIG. 28 is a flowchart showing the first half part of the processing for measuring the body following ability which is executed by the processor 20 of FIG. 2.

FIG. 29 is a flowchart showing the last half part of the processing for measuring the body following ability which is executed by the processor 20 of FIG. 2.

FIG. 30 is a flowchart showing the last half part of the processing for measuring the difference which is executed by the processor 20 of FIG. 2.

FIG. 31 is a view for showing an example of a measurement screen in the first judgment measurement mode in accordance with the embodiment.

FIG. 32 is a flowchart showing the first judgment measurement process which is executed by the processor 20 of FIG. 2.

FIG. 33 is a flowchart showing the task decision process (the first stage) in step S562 of FIG. 32.

FIG. 34 is a flowchart showing the task decision process (the third stage) in step S562 of FIG. 32.

FIG. 35 is a view for showing an example of a measurement screen in the second judgment measurement mode in accordance with the embodiment.

FIG. 36 is a flowchart showing the second judgment measurement process which is executed by the processor 20 of FIG. 2.

FIG. 37 is a view for showing an example of a measurement screen in the third judgment measurement mode in accordance with the embodiment.

FIG. 38 is a flowchart showing the third judgment measurement process which is executed by the processor 20 of FIG. 2.

FIG. 39 is a flowchart showing the processing for determining right and wrong in step S672 of FIG. 35.

FIG. 40 is a view for showing an example of a task screen in the memory measurement mode in accordance with the embodiment.

FIG. 41 is a view for showing an example of an answer screen in the memory measurement mode in accordance with the embodiment.

FIG. 42 is a flowchart showing the first half part of the processing for measuring the memory ability which is executed by the processor 20 of FIG. 2.

FIG. 43 is a flowchart showing the last half part of the processing for measuring the memory ability which is executed by the processor 20 of FIG. 2.

FIG. 44 is a view for showing an example of a measurement screen in the motor performance measurement mode in accordance with the embodiment.

FIG. 45 is flowchart showing the processing for measuring the motor performance which is executed by the processor 20 of FIG. 2.

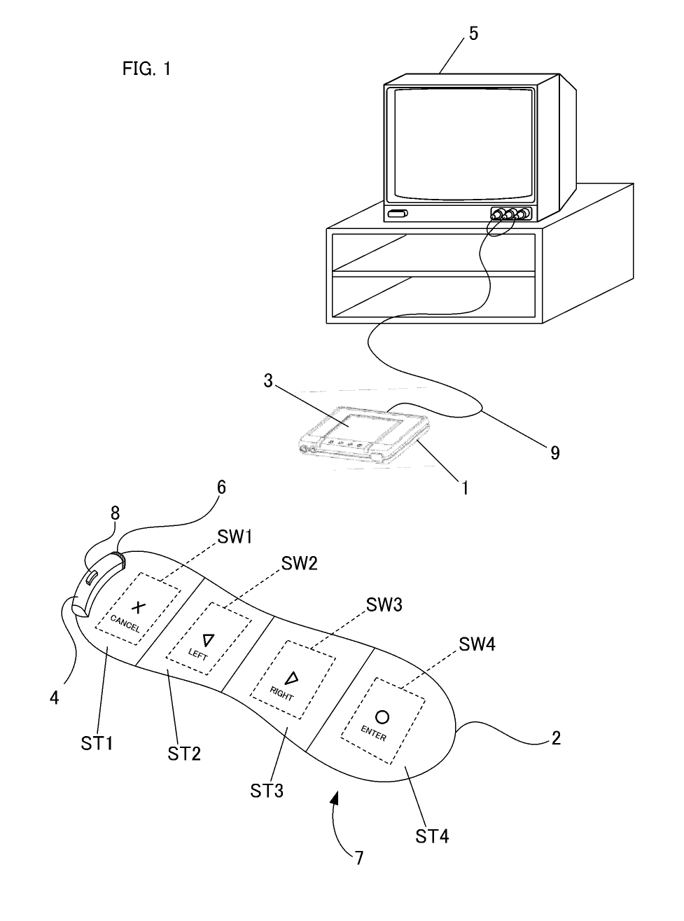

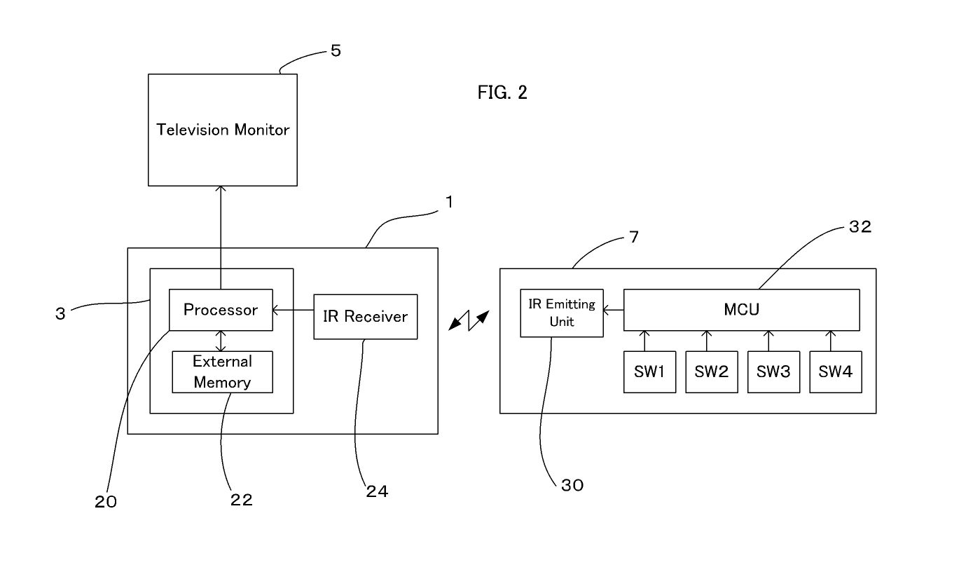

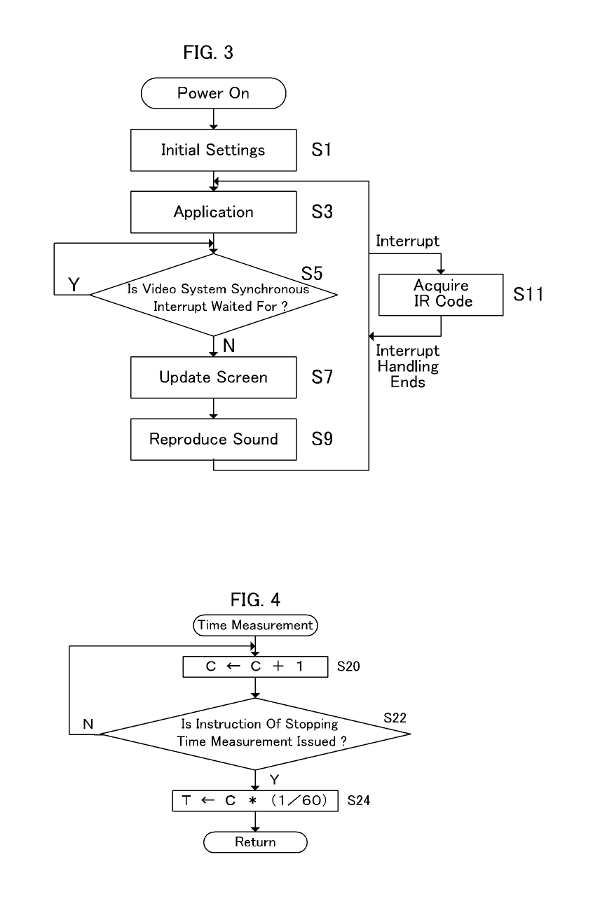

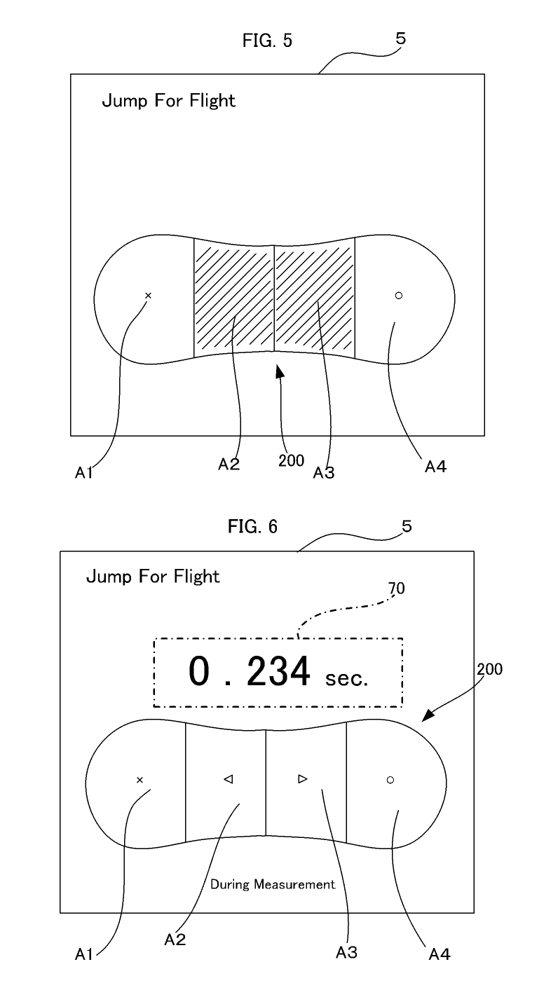

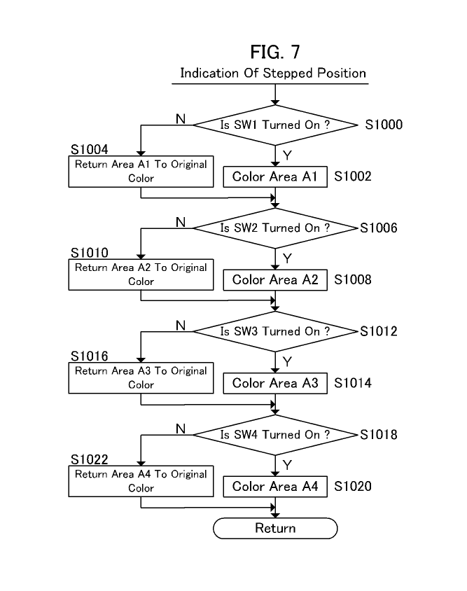

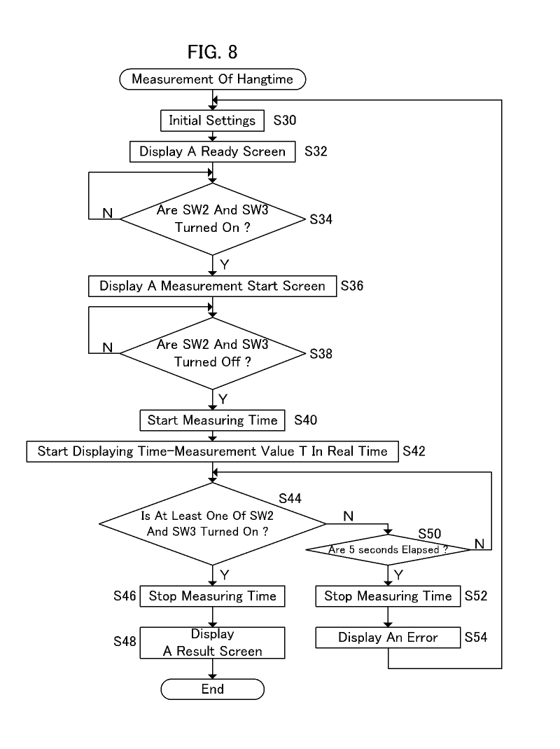

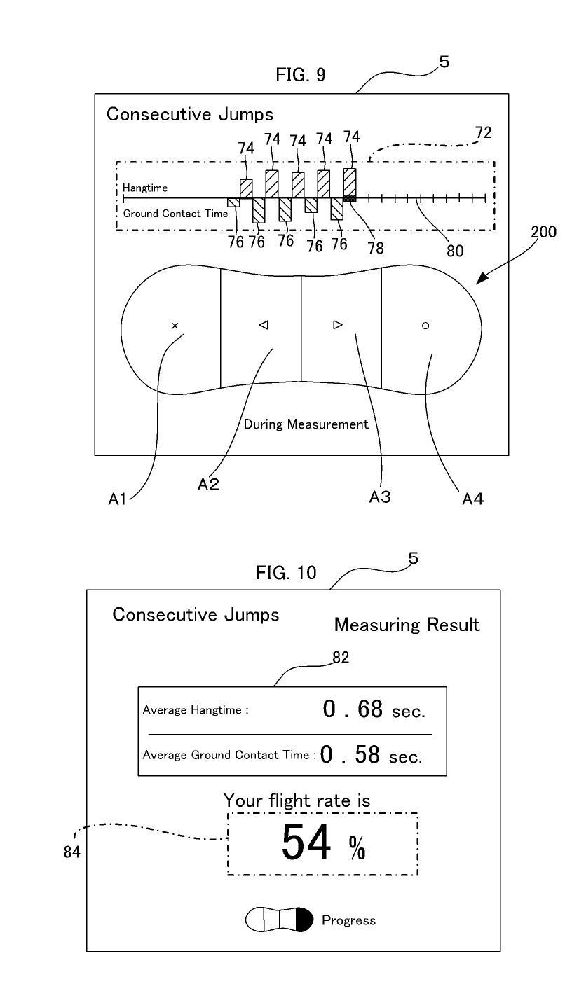

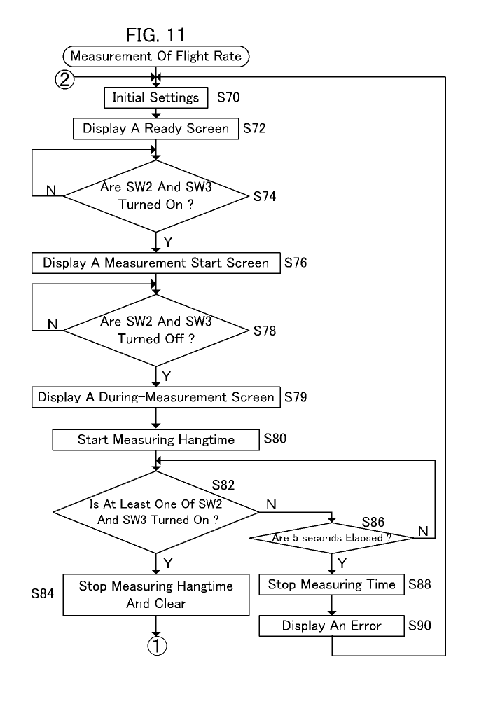

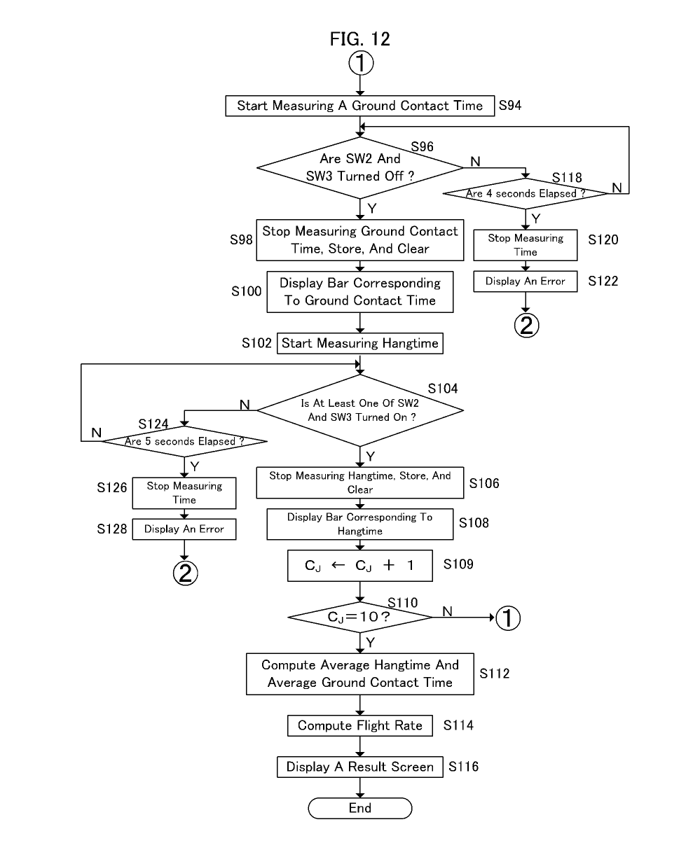

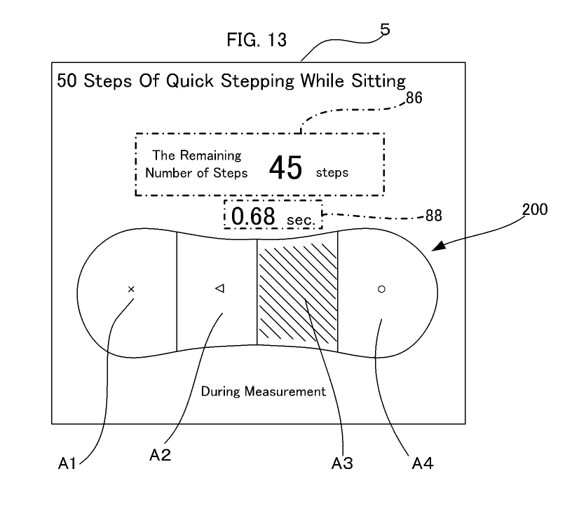

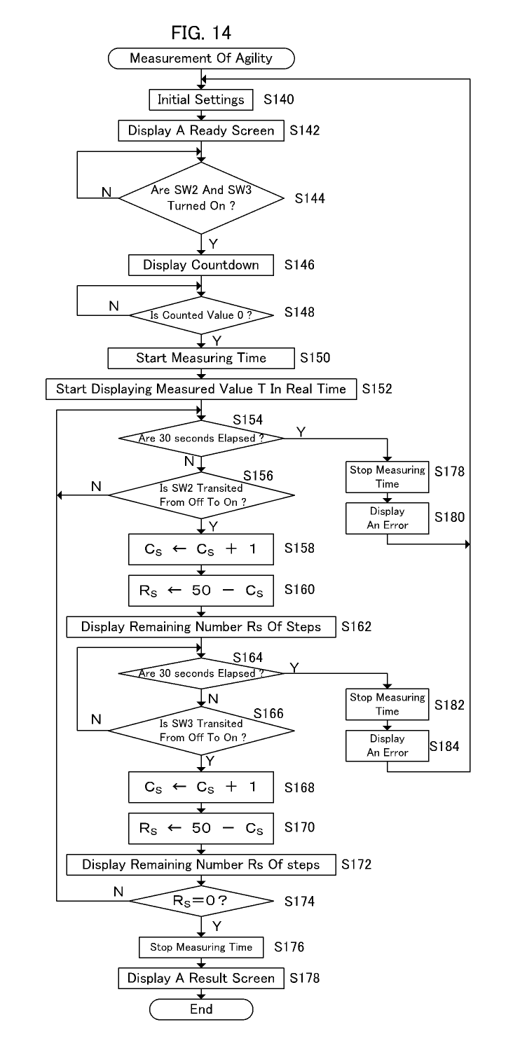

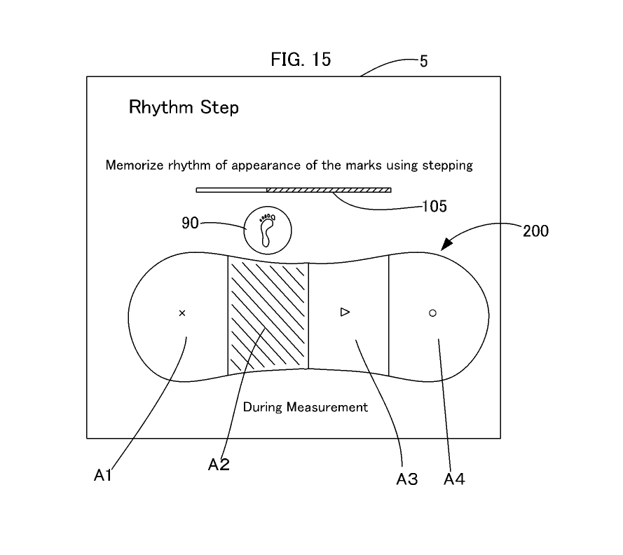

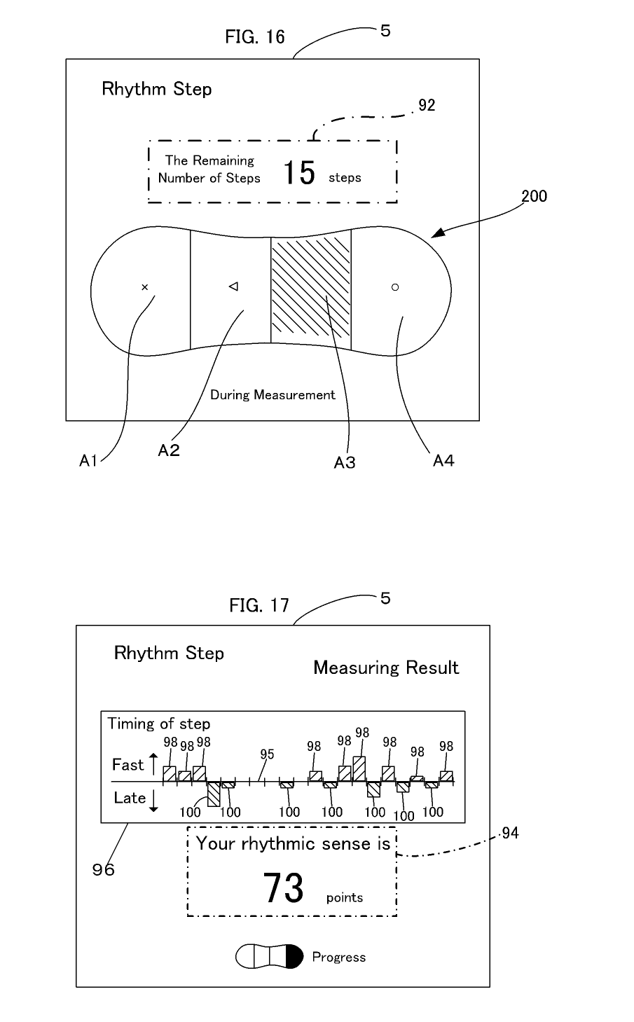

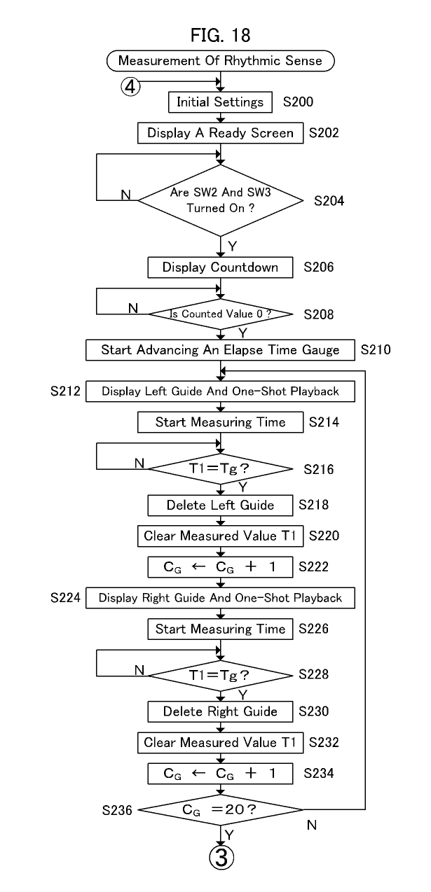

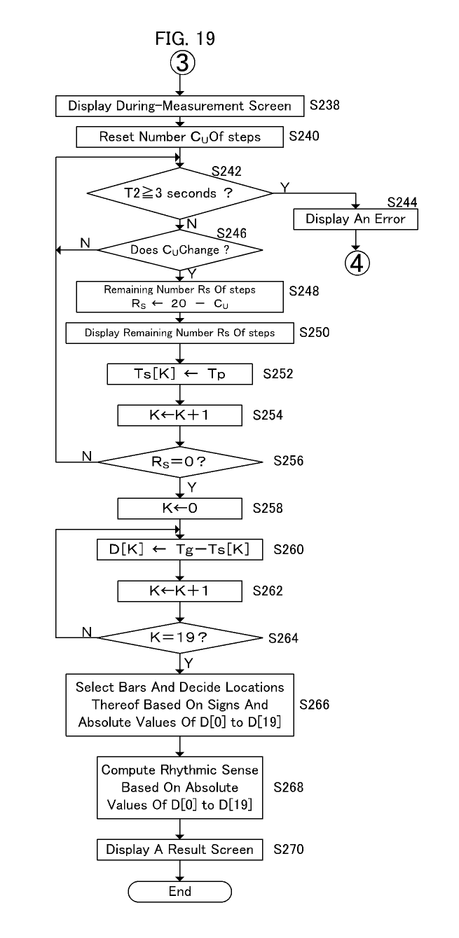

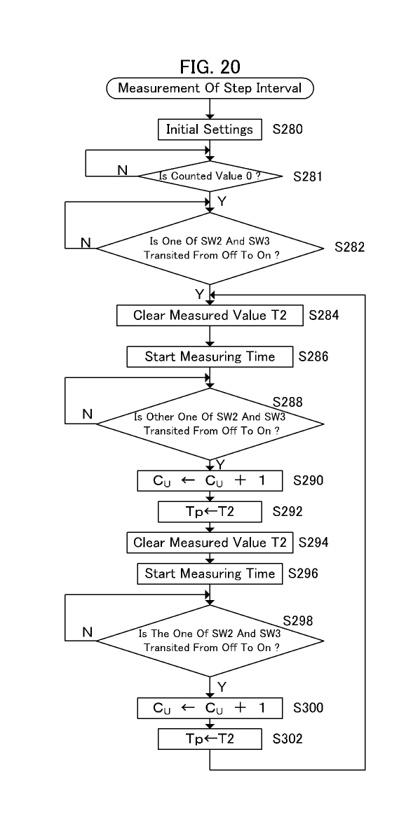

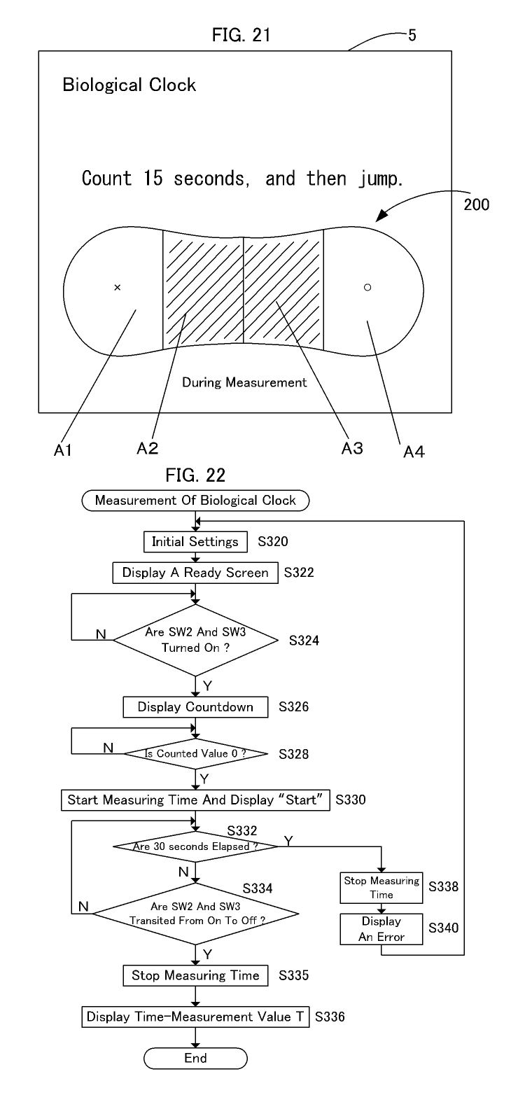

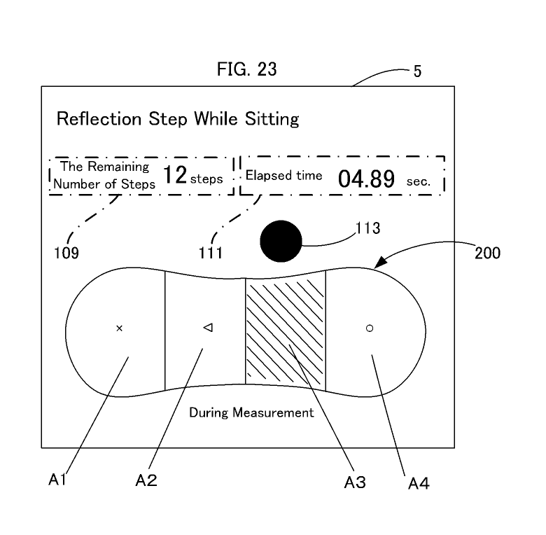

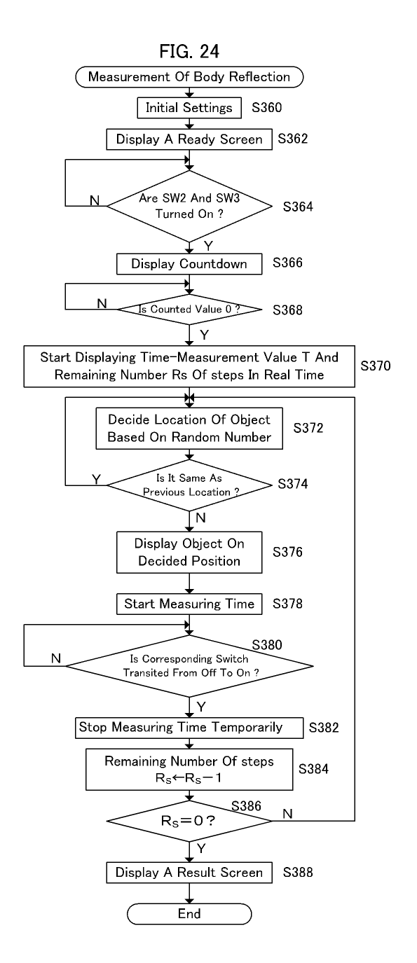

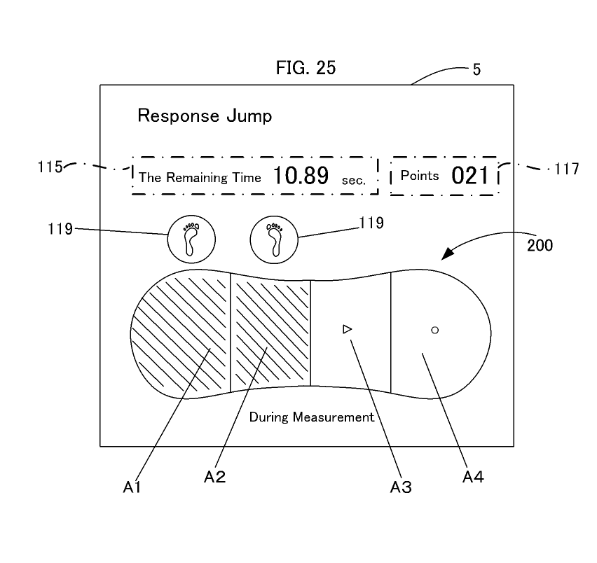

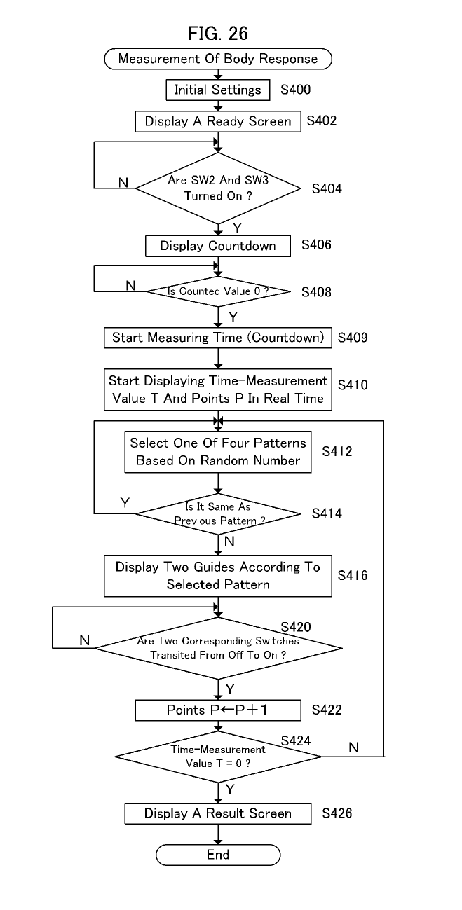

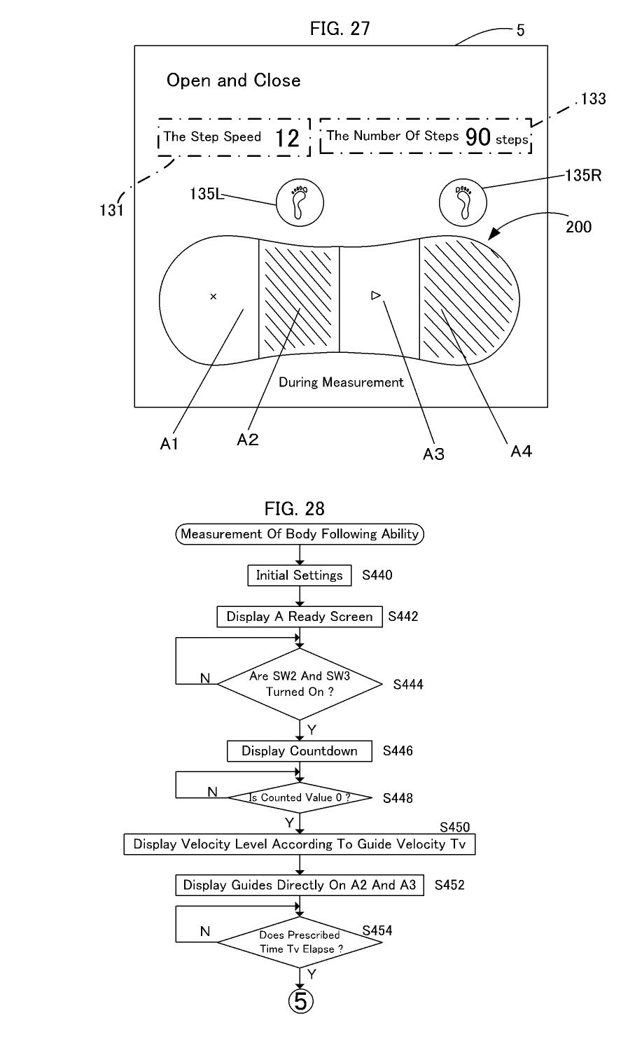

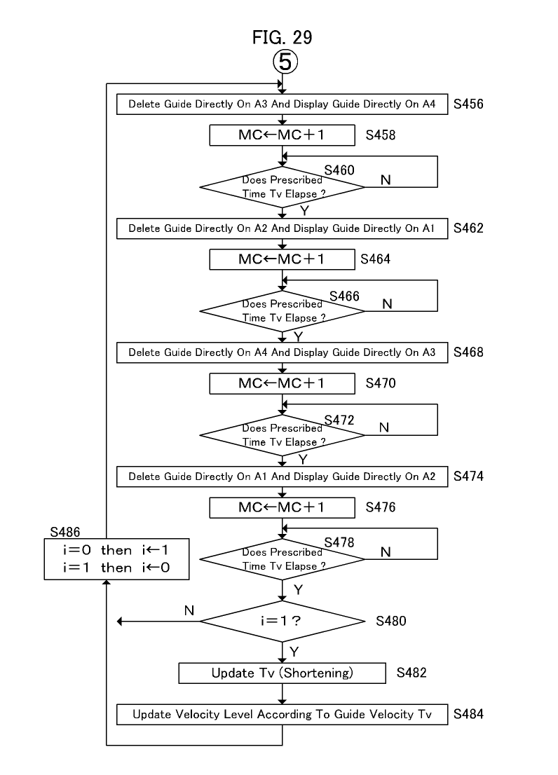

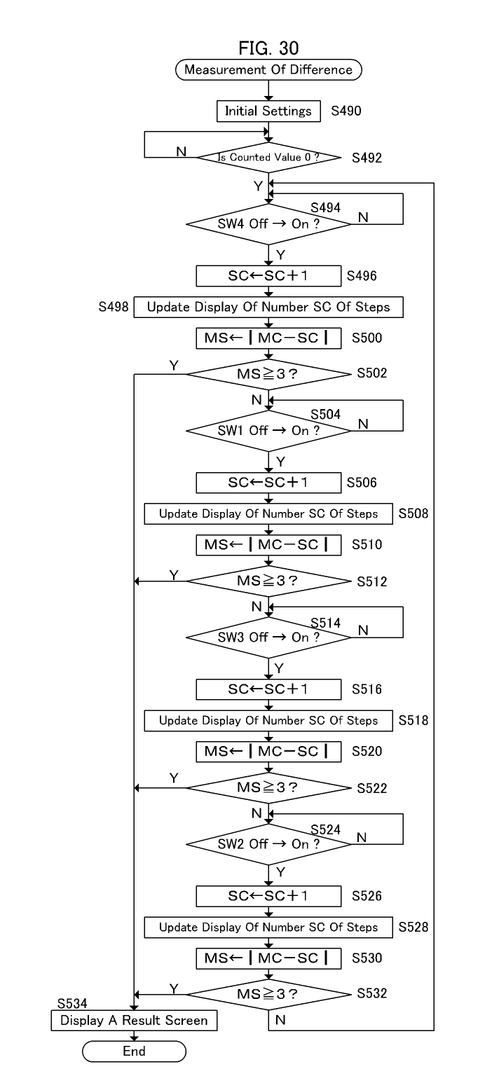

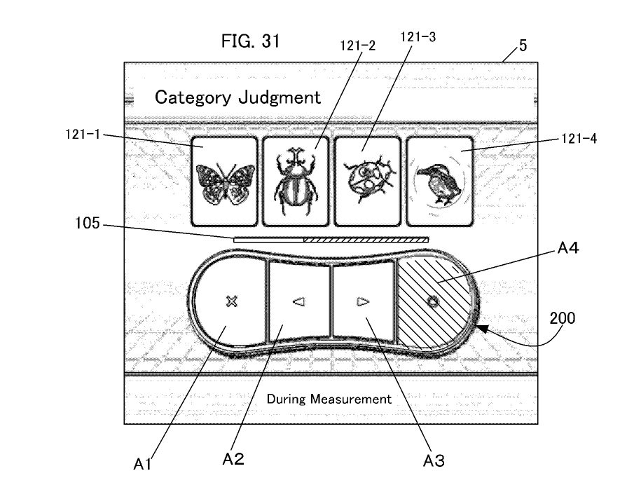

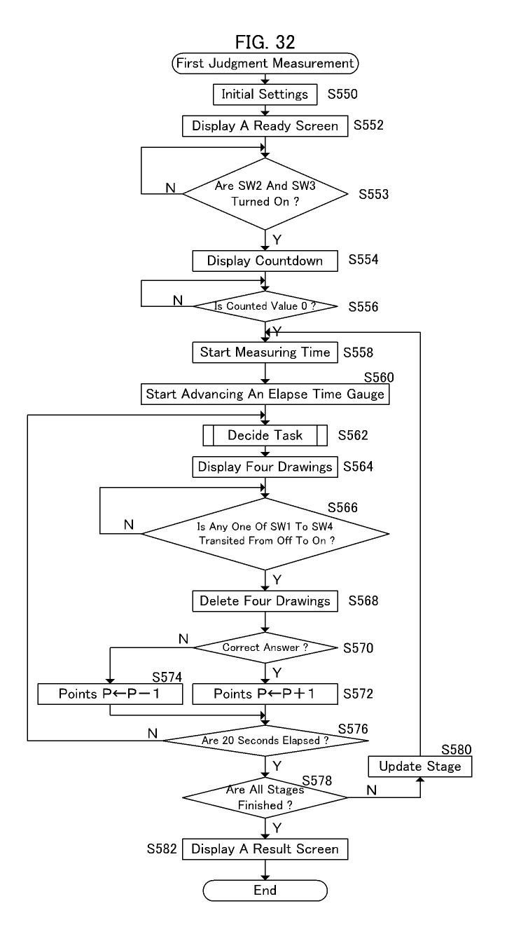

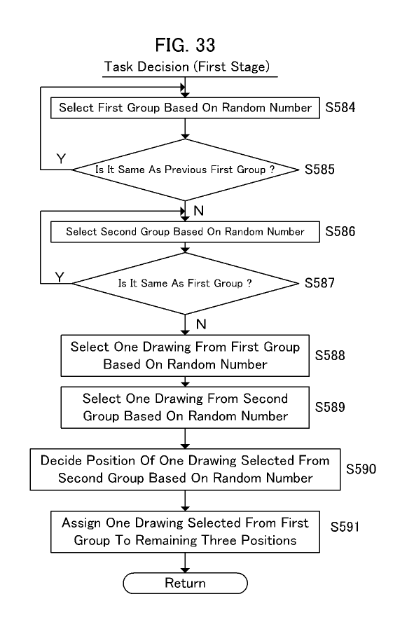

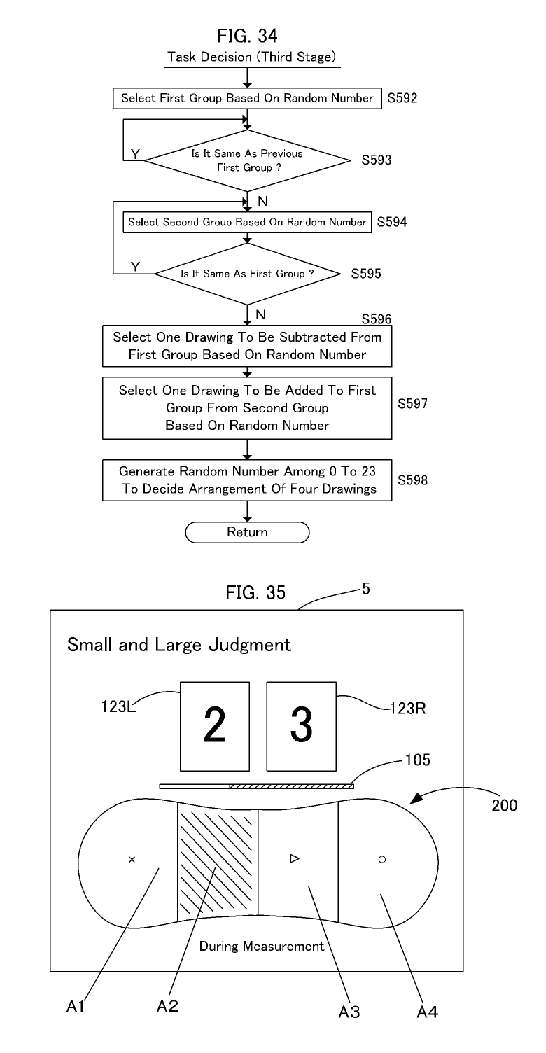

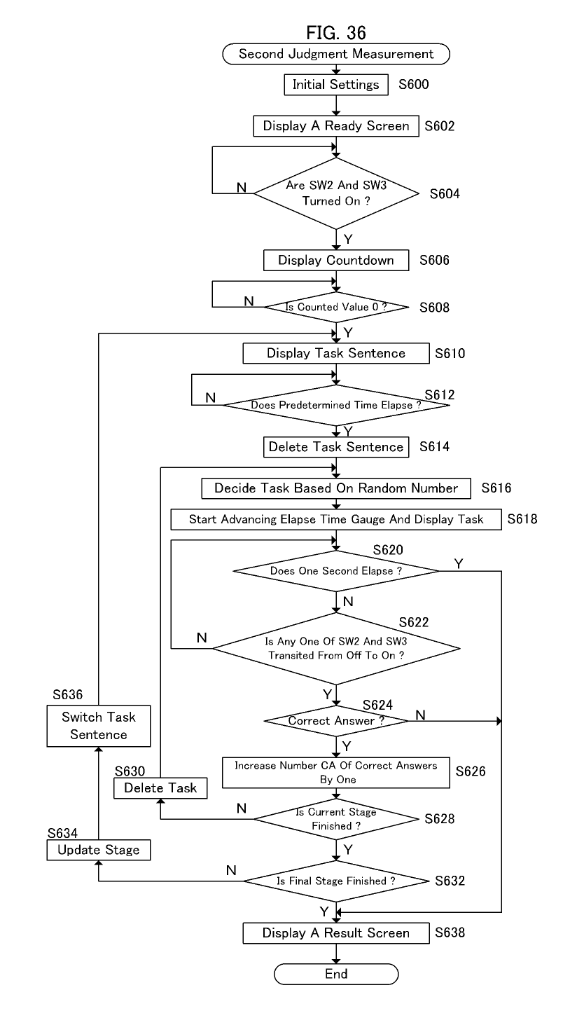

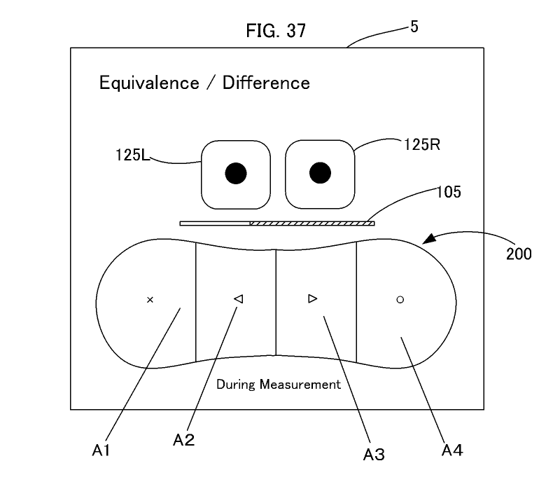

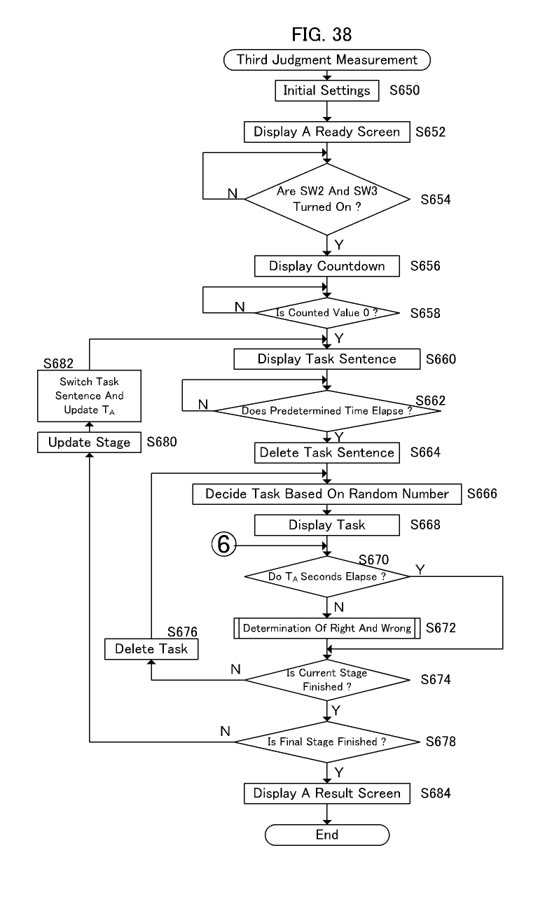

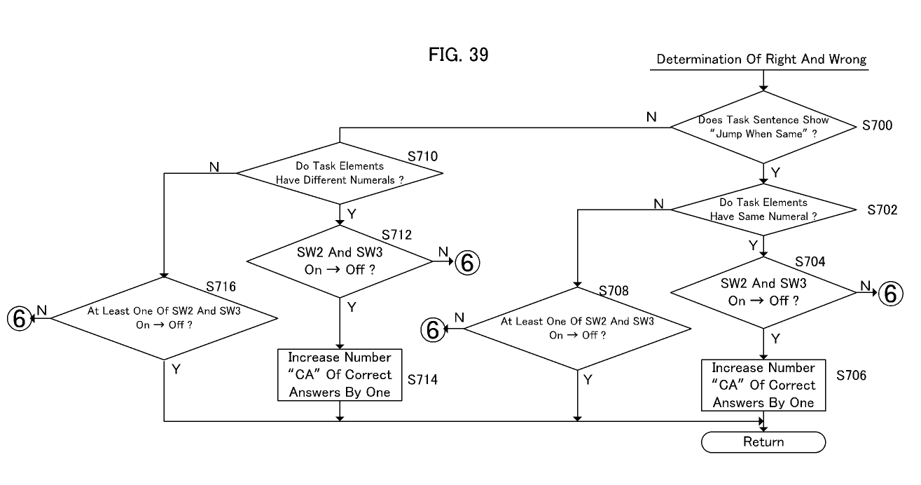

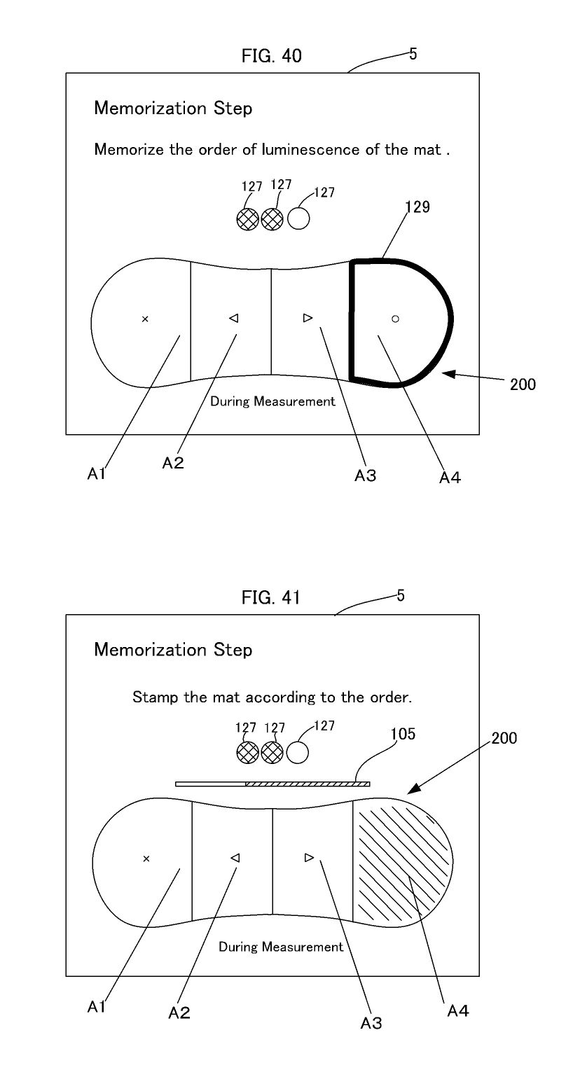

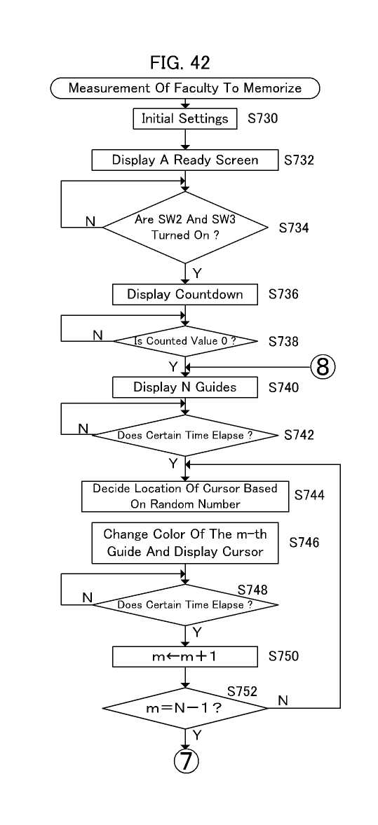

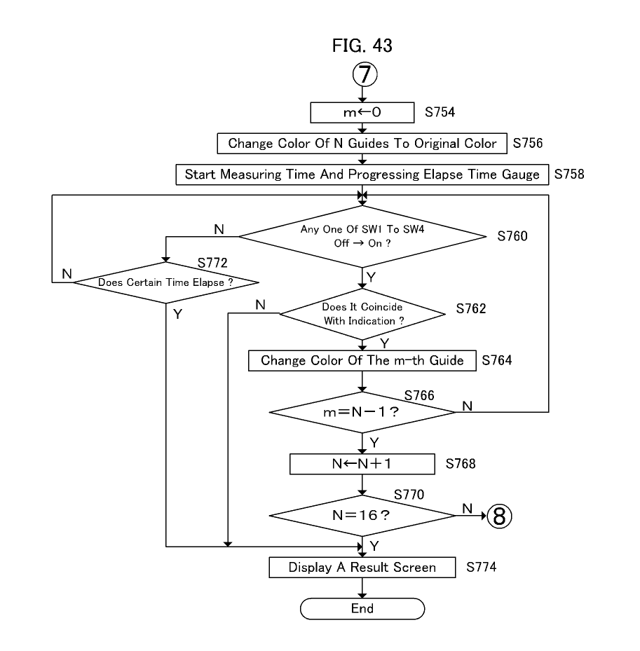

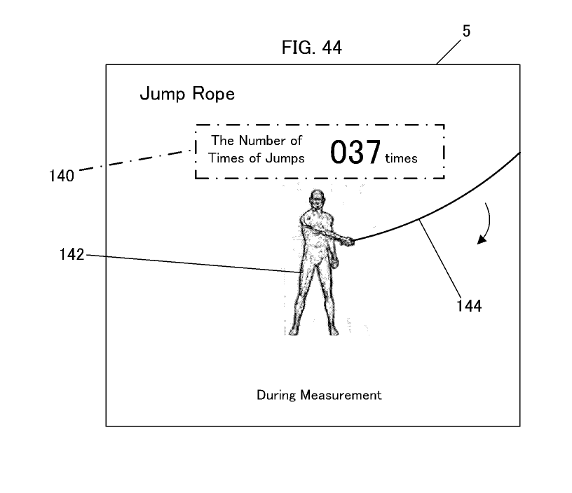

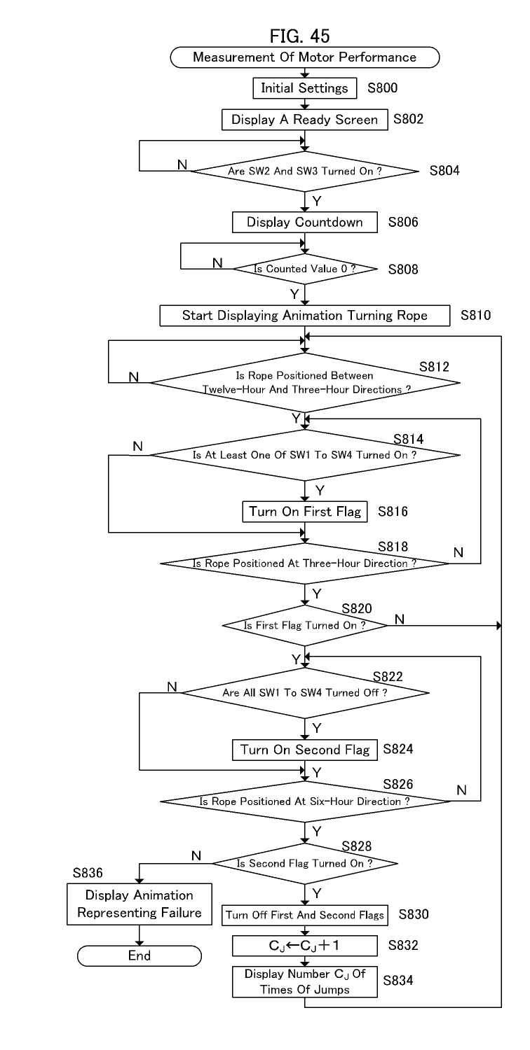

### EXPLANATION OF REFERENCES

1 . . . adapter, 3 . . . cartridge, 5 . . . television monitor, 7 . . . mat unit, 20 . . . processor, 22 . . . external memory, 24 . . . IR receiver, 30 . . . IR emitting unit, 32 . . . MCU, and SW1 to SW4 . . . foot switch.

1. A function measurement apparatus to be used in connection with a display device, comprising:
a detecting unit operable to detect step action as input from a test subject;
a measuring unit operable to measure a time from when said detecting unit detects the step action to when a predetermined number of times of the step action is detected; and
a display control unit operable to display a measuring result of said measuring unit on the display device.

2. A function measurement apparatus as claimed in claim 1, wherein said detecting unit detects the step action which the test subject performs in a state of sitting.

3. A function measurement apparatus to be used in connection with a display device, comprising:
a detecting unit operable to detect step action as input from a test subject;
a guide unit operable to guide timing of stepping at a predetermined time interval by an image and/or audio;
a measuring unit operable to measure a step interval, which is a time from when said detecting unit detects the step action to when the next step action is detected;
a difference calculating unit operable to a difference between the predetermined time interval and the step interval measured after finishing the guide; and
a display control unit operable to display an image for representing the difference visually on the display device,
wherein said measuring unit measures the step interval for the each step action until said detecting unit detects a predetermined number of times of the step action, and
wherein said difference calculating unit calculates the difference for the each step action.

4. A function measurement apparatus to be used in connection with a display device, comprising:
a detecting unit operable to detect jump action as input from a test subject;
a hangtime measuring unit operable to measure a hangtime, which is a time from when said detecting unit detects flight of the test subject to when ground contact of the test subject is detected; and
a display control unit operable to display the hangtime as a measuring result of said hangtime measuring unit on the display device.

5. A function measurement apparatus as claimed in claim 4, further comprising:
a ground contact time measuring unit operable to measure a ground contact time, which is a time from when said detecting unit detects the ground contact of the test subject to when the flight is detected,
wherein said hangtime measuring unit measures a predetermined number of times of the successive hangtimes, and
wherein said ground contact time measuring unit measures the predetermined number of the times of the successive ground contact times.

6. A function measurement apparatus to be used in connection with a display device, comprising:
a detecting unit operable to detect ground contact and non-ground contact of a leg of a test subject;
an instructing unit operable to instruct the test subject to measure a predetermined time by the display device or audio;
a starting unit operable to show a point of time when time-measurement is started to the test subject by the display device or audio after the instructing; and
a time-measurement unit operable to start the time-measurement from the point of the time when the time-measurement is started, and finish the time-measurement when said detecting unit detects a predetermined transition of a transition from the ground contact of the leg to the non-ground contact and a transition from the non-ground contact of the leg to the ground contact.

7. A function measurement apparatus to be used in connection with a display device, comprising:
a detecting unit operable to detect stamp action as input from a test subject;
a guide unit operable to indicates a stamp position where the test subject has to stamp;
a time-measurement unit operable to start time-measurement from a point of time when the guide unit indicates the stamp position where the test subject has to stamp, and finish the time-measurement when the test subject stamps the stamp position; and
a result display unit operable to display a time-measurement result of said time-measurement unit on the display device.

8. A function measurement apparatus as claimed in claim 7, wherein said guide unit repeatedly indicates the stamp position where the test subject has to stamp.

9. A function measurement apparatus to be used in connection with a display device, comprising:
a detecting unit operable to detect stamp action as input from a test subject;
a guide unit operable to repeatedly indicates a stamp position where the test subject has to stamp, using the display device;
a time-measurement unit operable to start time-measurement from a point of time when the guide unit first indicates the stamp position where the test subject has to stamp, and finish the time-measurement when a predetermined time elapses; and
a counting unit operable to count a number of times of stamps when the test subject stamps the stamp position indicated by the guide unit; and
a result display unit operable to display a count result of said counting unit on the display device.

10. (canceled)

11. A function measurement apparatus to be used in connection with a display device, comprising:
a detecting unit operable to detect stamp action as input from a test subject; and
a correspondence image display unit operable to display a plurality of correspondence images corresponding to a plurality of stamp positions on the display device; and
an information display unit operable to display two information display sections corresponding to two of the plurality of the correspondence images on the display device.

12. A function measurement apparatus as claimed in claim 11, wherein said information display unit displays information in one of the plurality of the information display sections, and
wherein the information has a different kind of content from a content of information to be displayed in the other information display section.

13. A function measurement apparatus as claimed in claim 11, wherein said information display unit displays the two information display sections corresponding to the two correspondence images of the plurality of the correspondence images to display information indicating different numerals from each other therein.

14. A function measurement apparatus as claimed in claim 11, wherein said information display unit displays the two information display sections corresponding to the two correspondence images of the plurality of the correspondence images to display either information indicating different numerals from each other or information indicating same numerals as each other therein.

15. (canceled)

16. A function measurement apparatus to be used in connection with a display device, comprising:
a detecting unit operable to detect full body motion of a test subject;
a display control unit operable to display an object, which moves in a cyclic manner, on the display device;
a determining unit operable to determine success and failure based on a detection result of said detecting unit and a position of the object for each cycle; and
a counting unit operable to increase a counted value when the determining unit determines the success.

17. A function measurement apparatus as claimed in claim 16, wherein when a first predetermined motion of the test subject is detected during a first period of the one cycle of the object, said determining unit determines the success if a second predetermined motion of the test subject is detected during a second period following the first period, and determines the failure if the second motion is not detected during the second period.

18. A function measurement apparatus as claimed in claim 16, wherein the object is a curved line in appearance, and
wherein the movement in the cyclic manner is rotational movement.

19. A function measurement apparatus as claimed in claim 1, wherein said detecting unit is a mat, including:
a plurality of stamp parts; and
a plurality of switches each of which is disposed under the corresponding stamp part.

20. A function measurement apparatus as claimed in claim 3, wherein said detecting unit is a mat, including:
a plurality of stamp parts; and
a plurality of switches each of which is disposed under the corresponding stamp part.

21. A function measurement apparatus as claimed in claim 4, wherein said detecting unit is a mat, including:
a plurality of stamp parts; and
a plurality of switches each of which is disposed under the corresponding stamp part.

22. A function measurement apparatus as claimed in claim 6, wherein said detecting unit is a mat, including:
a plurality of stamp parts; and
a plurality of switches each of which is disposed under the corresponding stamp part.
